(19) United States
(12) Patent Application Publication
(10) Pub. No.: US 2026/0284465 A1
(43) Pub. Date: Sep. 24, 2026

(54) CONTROL METHOD FOR CONTROLLING WEARABLE DEVICE ON BASIS OF EXERCISE DATA OF USER AND ELECTRONIC DEVICE FOR PERFORMING SAME

(71) Applicant: SAMSUNG ELECTRONICS CO., LTD., Suwon-si (KR)

(72) Inventors: Jungsik HWANG, Suwon-si (KR); Kyungrock KIM, Suwon-si (KR); Sukwon CHOI, Suwon-si (KR)

(21) Appl. No.: 19/689,066

(22) Filed: May 27, 2026

Related U.S. Application Data
(63) Continuation of application No. PCT/KR2024/021379, filed on Dec. 30, 2024.

(30) Foreign Application Priority Data
Feb. 2, 2024 (CN) 10-2024-0016790
Apr. 16, 2024 (CN) 10-2024-0050692

(51) Int. Cl. A63B 21/00; A63B 24/00; A63B 71/06; G06N 3/08

(52) U.S. Cl. CPC A63B 21/4025; A63B 24/0062; A63B 24/0087; A63B 71/0622; G06N 3/08; A63B 2024/0093; A63B 2220/22; A63B 2220/30; A63B 2220/836; A63B 2230/067

(57) ABSTRACT

A control method for controlling a wearable device on the basis of exercise data of a user, and/or an electronic device for performing same. An example control method may include: receiving a user input about an exercise goal; determining a torque parameter, associated with achieving the exercise goal, using a neural network model that uses feature data, associated with an exercise performed by a user wearing a wearable device, as input, and outputs an estimated exercise performance indicator; and transmitting a control signal including the determined torque parameter to the wearable device so that the wearable device generates torque on the basis of the determined torque parameter.

### CROSS-REFERENCE TO RELATED APPLICATIONS

This application is a continuation application of International Application No. PCT/KR2024/021379, filed on Dec. 30, 2024, in the Korean Intellectual Property Receiving Office, and claiming priority to KR Application No. 10-2024-0016790 filed Feb. 2, 2024 and KR Application No. 10-2024-0050692 filed Apr. 16, 2024, the disclosures of which are all hereby incorporated by reference herein in their entireties.

### TECHNICAL FIELD

Certain example embodiments may relate to a control method of controlling a wearable device based on exercise data of a user and/or an electronic device performing the same.

### BACKGROUND

In general, a walking assistance device may refer to a mechanism and/or device that helps a patient, who for example cannot walk on his own due to various diseases, accidents, and/or the like, to perform walking exercises for rehabilitation treatment, and/or a mechanism or device that can be used for exercise. With the recent intensifying aging societies, a growing number of people experience inconvenience in walking or have difficulty in normal walking due to malfunctioning joint issues, and there is increasing interest in walking assistance devices. A walking assistance device may be mounted, directly or indirectly, on the body of a user, for example, to assist the user with walking by providing a necessary muscular strength and to induce the user to walk in a normal walking pattern. The walking assistance device may assist the user with various leg exercises (e.g., one or more of power walking, jogging, stair climbing, lunging, and stretching).

### SUMMARY

A control method of controlling a wearable device based on exercise data of a user, according to an example embodiment, may include receiving a user input for an exercise goal, determining a torque parameter related to achievement of the exercise goal by using a neural network model that receives, as an input, feature data related to an exercise performed by the user while wearing the wearable device and outputs an estimated exercise performance indicator, and transmitting a control signal including the determined torque parameter to the wearable device such that the wearable device generates torque based on the determined torque parameter.

An electronic device, according to an example embodiment, may include one or more processors (each “processor” comprising processing circuitry and one or more processors), an input circuit configured to receive a user input, and a communication circuit configured to communicate with a wearable device. The one or more processors may individually and/or collectively determine, in response to receiving a user input for an exercise goal through the input circuit, a torque parameter related to achievement of the exercise goal by using a neural network model that receives, as an input, feature data related to an exercise performed by a user while wearing the wearable device and outputs an estimated exercise performance indicator. The one or more processors may individually and/or collectively control the wearable device to generate torque based on the determined torque parameter by causing the communication circuit to transmit a control signal including the determined torque parameter to the wearable device.

### BRIEF DESCRIPTION OF DRAWINGS

These and/or other aspects, features, and advantages will become apparent and more readily understood from the following description of exemplary embodiments, taken in conjunction with the accompanying drawings.

FIG. 1 is a diagram illustrating an overview of a wearable device worn on a body of a user according to various example embodiments.

FIG. 2 is a drawing illustrating an exercise assistance system according to various example embodiments.

FIG. 3 is a rear schematic view of a wearable device according to various example embodiments.

FIG. 4 is a left side view of a wearable device according to various example embodiments.

FIG. 5 is a diagram illustrating components of a wearable device according to various example embodiments.

FIG. 6 is a diagram illustrating an interaction between a wearable device and an electronic device according to various example embodiments.

FIG. 7 is a diagram illustrating components of an electronic device according to various example embodiments.

FIG. 8 is a diagram illustrating a system for controlling a wearable device based on exercise data of a user according to various example embodiments.

FIGS. 9 and 10 are diagrams illustrating input/output data and a training operation of a neural network model according to various example embodiments.

FIG. 11 is a flowchart illustrating operations of a control method of controlling a wearable device based on exercise data of a user according to various example embodiments.

FIG. 12 is a diagram illustrating an operation of determining a torque parameter related to achievement of an exercise goal by using a neural network model according to various example embodiments.

FIG. 13 is a flowchart illustrating operations of a control method of controlling a wearable device based on exercise data of a user according to various example embodiments.

FIGS. 14A, 14B, and 14C are diagrams illustrating a cable-based wearable device and determining a torque parameter for the cable-based wearable device according to various example embodiments.

### DETAILED DESCRIPTION

The following detailed structural or functional description is provided as an example only and various alterations and modifications may be made to the examples. Accordingly, the embodiments are not to be construed as limited to the disclosure and should be understood to include all changes, equivalents, or replacements within the idea and the technical scope of the disclosure.

As used herein, the singular form is intended to include the plural forms as well, unless the context clearly indicates otherwise. It will be understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments are described in detail with reference to the accompanying drawings. When describing the embodiments with reference to the accompanying drawings, like reference numerals refer to like elements and a repeated description related thereto will be omitted.

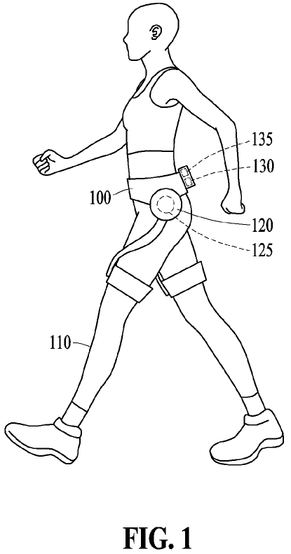

FIG. 1 is a diagram illustrating an overview of a wearable device worn on a body of a user according to various embodiments.

Referring to FIG. 1, in an embodiment, a wearable device 100 may be a device worn on a body of a user 110 to assist the user 110 in walking, exercising, and/or working. The wearable device 100 may be used to measure a physical ability (e.g., a walking ability, an exercise ability, or an exercise posture) of the user 110. In embodiments, the term “wearable device” may be replaced with “wearable robot,” “walking assistance device,” or “exercise assistance device”. The user 110 may be a person who walks, exercises, or performs a task while wearing the wearable device 100.

The wearable device 100 may be worn on a body (e.g., a lower body (the legs, ankles, knees, etc.) and/or an upper body (the torso, arms, wrists, etc.)) of the user 110 to apply an external force such as an assistance force and/or a resistance force to a body motion of the user 110. The assistance force may be a force assisting the body motion of the user 110, which is applied in the same direction as a direction of the body motion of the user 110. The resistance force may be a force applied in a direction opposite to the body motion direction of the user 110, the force hindering a body motion of the user 110. The term “resistive force” may also be referred to as an “exercise load”.

In an embodiment, the wearable device 100 may operate in a walking assistance mode for assisting the user 110 in walking. In the walking assistance mode, the wearable device 100 may assist the user 110 in walking by applying an assistance force generated by a driving module 120 of the wearable device 100 to the body of the user 110. The wearable device 100 may enable the user 110 to walk independently or to walk for a long time by providing a force required for the user 110 to walk, thereby expanding the walking ability of the user 110. The wearable device 100 may help improve the walking of a user having an abnormal walking habit or gait posture.

In an embodiment, the wearable device 100 may operate in an exercise assistance mode for enhancing the effect of exercise of the user 110 or providing various exercise experiences to the user 110. The exercise assistance mode may include a resistance mode and an assistance mode. The resistance mode of the exercise assistance mode may be a mode for hindering a body motion of the user 110 or providing resistance to a body motion of the user 110 by applying a resistance force generated by the driving module 120 to the body of the user 110. When the wearable device 100 is a hip-type wearable device that is worn on the waist (or pelvis) and legs (e.g., thighs) of the user 110, the wearable device 100 may provide an exercise load to a leg motion of the user 110 while being worn on the legs in the resistance mode, thereby enhancing the effect of exercise on the legs of the user 110. The assistance mode of the exercise assistance mode may be a mode for applying an assistance force to assist with a body motion of the user 110 to the body of the user 110. In the assistance mode, an assistance force in the same direction as a body motion may be provided to the user 110. For example, when a person with a disability or an elderly person wears the wearable device 100 to exercise, the wearable device 100 may provide an assistance force to assist a body motion. In the assistance mode, the wearable device 100 may provide a force in the same direction as a direction of the leg motion of the user 110, and the user 110 may exercise with a small force through the force provided by the wearable device 100. In an exercise program performed using the wearable device 100, the resistance mode and the assistance mode may be combined and operated. For example, the wearable device 100 may provide an assistance force and a resistance force in combination for each exercise session or time interval in such a manner of providing an assistance force in one exercise session and providing a resistance force in another exercise session. In the exercise assistance mode, various exercise programs may be operated depending on the exercise purpose and/or a physical ability of the user 110. The exercise program may be exercise content that the user 110 performs using the wearable device 100 and may include, for example, aerobic exercises, strength training, posture balancing, or any combination thereof. The types of exercise programs are not limited thereto and may vary. The resistance mode and the assistance mode may be alternately activated appropriately depending on an exercise program performed by the wearable device 100, and a target exercise speed that is suitable for an appropriate physical condition (e.g., a heart rate) of the user 110 may be guided to the user during the exercise of the user 110.

In an embodiment, the wearable device 100 may operate in a physical ability measurement mode for measuring a physical ability of the user 110. The wearable device 100 may measure motion information of the user 110 using sensors (e.g., an angle sensor 125 and an inertial measurement unit (IMU) 135) provided in the wearable device 100 during the walking and/or exercise of the user 110 and may assess the physical ability of the user 110 based on the measured motion information. For example, a walking index (e.g., the number of steps, the total walking distance, or a stride length) or an exercise ability indicator (e.g., muscular strength, exercise endurance, or posture balance) of the user 110 may be estimated through the motion information of the user 110 measured by the wearable device 100.

In some embodiments, the description is provided based on an example of the hip-type wearable device 100 as shown in FIG. 1. However, the embodiments are not limited thereto. As described above, the wearable device 100 may also be worn on other body parts (e.g., the upper arms, lower arms, hands, calves, or feet) other than the waist and thighs. The shape and configuration of the wearable device 100 may vary depending on the body part on which the wearable device 100 is worn.

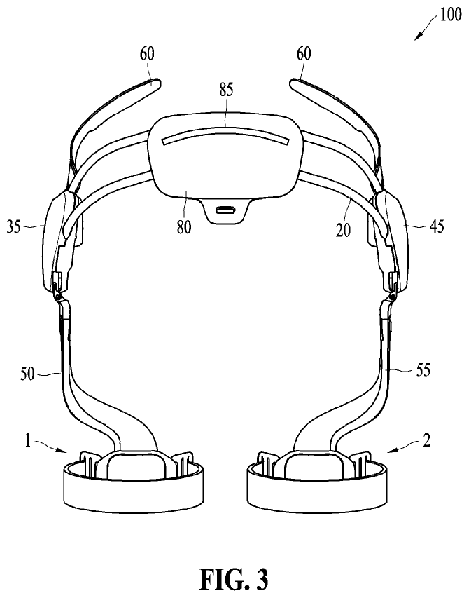

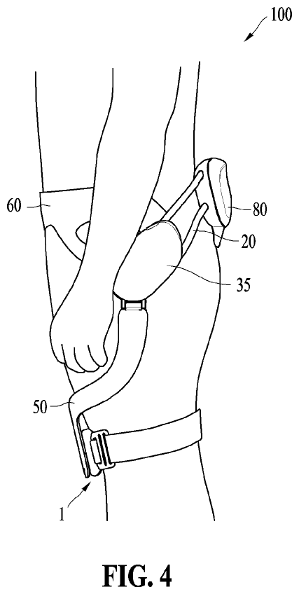

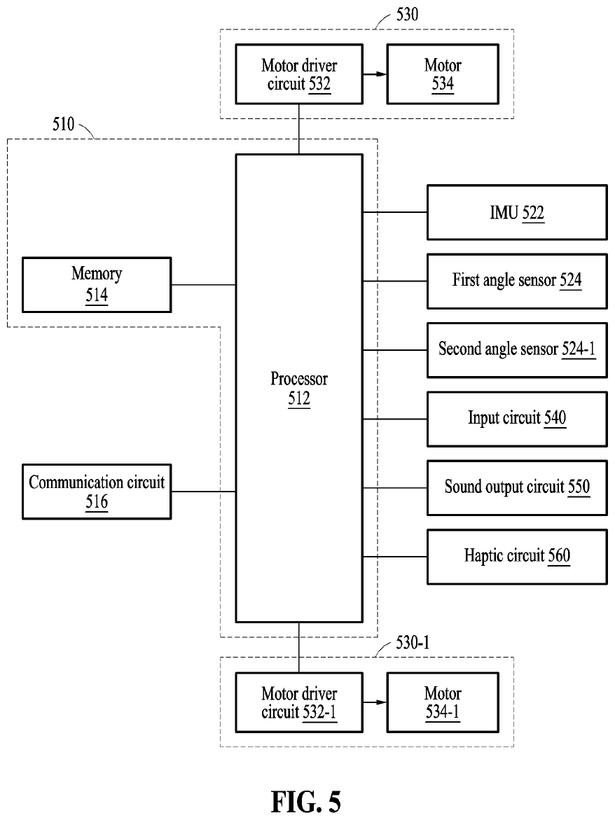

The wearable device 100 may include a support frame (e.g., a waist support frame 20 of FIGS. 3 and 4) configured to support the body of the user 110 when the wearable device 100 is worn on the body of the user 110, the driving module 120 (e.g., a first driving module 45 and a second driving module 35 of FIG. 3) configured to generate torque to be applied to the legs of the user 110, a torque transmission frame (e.g., a first torque transmission frame 55 and a second torque transmission frame 50 of FIG. 3) configured to transmit the torque generated by the driving module 120 to the legs of the user 110, a sensor circuit including one or more sensors configured to obtain sensor data including motion information on a body motion (e.g., a leg motion and an upper body motion) of the user 110, and a control circuit 130 (e.g., a control circuit 510 of FIG. 5) configured to control an operation of the wearable device 100.

In an embodiment, the wearable device 100 may include the angle sensor 125 and the IMU 135. The angle sensor 125 may measure a rotation angle of the torque transmission frame of the wearable device 100 corresponding to a hip joint angle of the user 110. The angle sensor 125 may include, for example, an encoder and/or a Hall sensor. In an embodiment, the angle sensor 125 may be disposed adjacent to a position where a motor included in the driving module 120 is connected to the torque transmission frame. The IMU 135 may include an acceleration sensor and/or an angular velocity sensor, and may measure a change in acceleration and/or angular velocity according to a motion of the user 110. The IMU 135 may measure, for example, a motion value of a waist support frame (e.g., the waist support frame 20 of FIG. 3) or a base body (e.g., a base body 80 of FIG. 3) of the wearable device 100. The motion value of the waist support frame or the base body measured by the IMU 135 may correspond to a waist motion value (or an upper body motion value) of the user 110.

In an embodiment, the control circuit 130 and the IMU 135 may be arranged within the base body (e.g., the base body 80 of FIG. 3) of the wearable device 100. The base body may be on the waist of the user 110 while the user 110 is wearing the wearable device 100. The base body may be formed on or attached to an outer side of the waist support frame of the wearable device 100. The base body may support the lumbar region of the user 110.

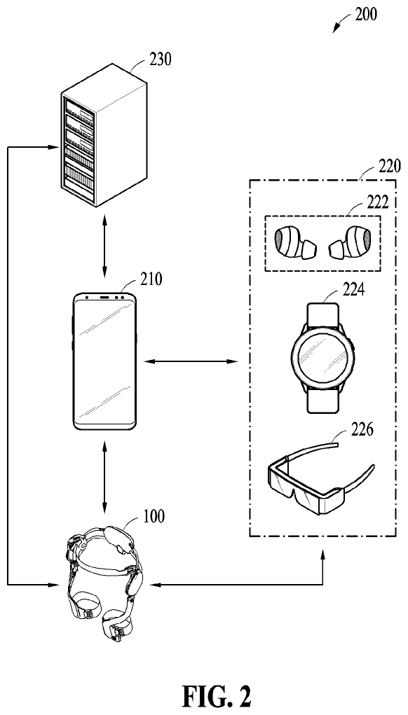

FIG. 2 is a drawing illustrating an exercise assistance system according to various embodiments.

Referring to FIG. 2, an exercise assistance system 200 may include the wearable device 100, an electronic device 210, another wearable device 220, and a server 230. At least one (e.g., the electronic device 210, the other wearable device 220, or the server 230) of the devices excluding the wearable device 100 may be omitted from the exercise assistance system 200, or one or more other devices (e.g., a dedicated controller for the wearable device 100) may be added to the exercise assistance system 200.

In an embodiment, the wearable device 100 may be worn on a body of a user in the walking assistance mode to assist a motion of the user. For example, the wearable device 100 may be worn on the legs of the user to help the user in walking by generating an assistance force for assisting a leg motion of the user.

In an embodiment, the wearable device 100 may generate and apply a resistance force for hindering a body motion of the user and/or an assistance force for assisting a body motion of the user to the body of the user to enhance an effect of the user's exercise in the exercise assistance mode. In the exercise assistance mode, the user may select an exercise program (e.g., aerobic exercise such as power walking and outdoor walking, strength training such as squats, split lunges, dumbbell squats, and lunge and knee ups, a stretching exercise, a posture balancing exercise, or any combination thereof) that the user desires to conduct using the wearable device 100 through the electronic device 210 and/or an exercise intensity applied to the exercise program. The wearable device 100 may control a driving module (e.g., the driving module 120 of FIG. 1) of the wearable device 100 based on the exercise program and/or exercise intensity selected by the user. The wearable device 100 may adjust the strength of the resistance force and/or the assistance force generated by the driving module based on the exercise intensity selected by the user. The wearable device 100 may control the driving module to generate a resistance force corresponding to the exercise intensity selected by the user. As the exercise intensity increases, the strength of the resistance force applied to the user may increase.

The wearable device 100 may transmit sensor data measured by a sensor (e.g., the angle sensor 125 or the IMU 135 of FIG. 1) to the electronic device 210, and receive a control signal to control an operation of the wearable device 100 from the electronic device 210.

The electronic device 210 may communicate with the wearable device 100 through wireless communication (e.g., Bluetooth communication) or wired communication, remotely control the wearable device 100, or provide state information on a state (e.g., a booting state, a charging state, an exercise program operation state, or an error state) of the wearable device 100 to the user. The electronic device 210 may recommend an exercise program using the wearable device 100 to the user and may analyze an exercise performed by the user. The electronic device 210 may receive sensor data obtained by the sensor of the wearable device 100 from the wearable device 100, and estimate a current exercise state, an exercise result, an exercise posture, and/or a physical ability of the user based on the received sensor data. The electronic device 210 may provide the user with the estimated current exercise state, exercise result, exercise posture, and/or physical ability of the user through a graphical user interface (GUI).

In an embodiment, the user may execute a program (e.g., an application) on the electronic device 210 to control the wearable device 100, and adjust an operation or a setting value (e.g., the magnitude of torque output from a motor of a driving module, the volume of audio output from a sound output circuit (e.g., a sound output circuit 550 of FIG. 5, or the brightness of a lighting unit (e.g., a lighting unit 85 of FIG. 3) of the wearable device 100 through the corresponding program. The program executed by the electronic device 210 may provide a GUI for an interaction with the user. The electronic device 210 may include various types of devices. For example, the electronic device 210 may include a portable communication device (e.g., a smartphone), a computer device, a portable multimedia device, or a home appliance (e.g., a television, an audio device, or a projector device), but is not limited thereto.

According to an embodiment, the electronic device 210 may be connected to the server 230 using short-range wireless communication or cellular communication. The server 230 may receive user profile information of the user who uses the wearable device 100 from the electronic device 210 and store and manage the received user profile information. The user profile information may include, for example, information on at least one of the name, age, gender, height, weight, medical history, or body mass index (BMI). The server 230 may receive exercise history information on an exercise performed by the user from the electronic device 210 and store and manage the received exercise history information. The server 230 may provide the electronic device 210 with various exercise programs or physical ability measurement programs to be provided to the user. In an embodiment, the server 230 may be connected to the wearable device 100. The server 230 may receive, from the wearable device 100, the sensor data measured by the wearable device 100 and transmit, to the wearable device 100, a control signal for controlling an operation of the wearable device 100 and/or data related to the exercise program. In an embodiment, the server 230 may be a cloud server.

According to an embodiment, the wearable device 100 and/or the electronic device 210 may be connected to the other wearable devices 220. Exercise result information, physical ability information, and/or exercise posture assessment information of the user that are determined by the electronic device 210 may be transmitted to the other wearable device 220 and provided to the user through the other wearable device 220. State information of the wearable device 100 may also be transmitted to the other wearable device 220 and provided to the user through the other wearable device 220. In an embodiment, the wearable device 100, the electronic device 210, and the other wearable device 220 may be connected to each other through wireless communication (e.g., Bluetooth communication or Wi-Fi communication). The other wearable device 220 may be, for example, wireless earphones 222, a smartwatch (or a watch-type wearable device) 224, or smartglasses (a wearable device in the type of glasses or goggles) 226, but is not limited thereto.

In an embodiment, the wireless earphones 222 may be wirelessly connected to the electronic device 210 and/or the wearable device 100 and may output a guiding voice, music, and/or sound effect related to the exercise program. The wireless earphones 222 may provide information related to the exercise program (e.g., introduction of the exercise program or a remaining exercise time) to the user or inquire about a selection of the user through the guiding voice. The wireless earphones 222 may include a microphone, and the microphone may receive a voice input from the user. The voice input received through the microphone may be transmitted to the electronic device 210, and voice recognition for the voice input may be performed by the electronic device 210.

In an embodiment, the smartwatch 224 may include a biometric sensor (e.g., a heart rate sensor or an electromyography sensor) configured to measure a biosignal, including heart rate information of the user, and transmit the biosignal measured by the biometric sensor to the electronic device 210 and/or the wearable device 100. For example, the electronic device 210 may estimate the heart rate information (e.g., the current heart rate, the maximum heart rate, and the average heart rate) and/or electromyography information of the user based on the biosignal received from the smartwatch 224, and provide the user with the estimated heart rate information and/or electromyography information. The heart rate information and/or the electromyography information may be used to determine the haptic intensity of haptic feedback provided through the wearable device 100.

In an embodiment, the smartwatch 224 may include an IMU configured to measure motion information of the user and/or a position sensor configured to measure position information of the user, and transmit the motion information and/or position information of the user to the electronic device 210 and/or the wearable device 100. The smartwatch 224 may include a communication circuit (e.g., a short-range communication circuit) for communicating with another device (e.g., the electronic device 210 or the wearable device 100). In an embodiment, the smartwatch 224 may provide an interface related to an exercise program through a display. The interface related to the exercise program may be implemented through a separate application installed on the smartwatch 224. The user may also control the wearable device 100 through the smartwatch 224.

In an embodiment, the smartglasses 226 may provide information to the user through a display in the form of glasses. For example, the smartglasses 226 may output information on the current exercise speed, a target exercise speed, the currently achieved exercise amount, the exercise time, and the biometric information, through the display in an exercise mode. In addition, the smartglasses 226 may output a screen for guiding the user with an exercise path.

FIG. 3 is a rear schematic view of a wearable device according to various embodiments. FIG. 4 is a left side view of a wearable device according to various embodiments.

Referring to FIGS. 3 and 4, the wearable device 100, according to an embodiment, may include base body 80, a waist support frame 20, a driving modules 35 and 45, torque transmission frames 50 and 55, thigh fasteners 1 and 2, and a waist fastener 60. The base body 80 may include a lighting unit 85. In an embodiment, at least one (e.g., the lighting unit 85) of the components may be omitted from the wearable device 100, or one or more other components may be added to the wearable device 100.

The base body 80 may be positioned on the lumbar region or abdomen of a user when the user wears the wearable device 100. In an embodiment, the base body 80 may be mounted, directly or indirectly, on the lumbar region of the user to provide a cushioning feeling to the lower back of the user and may support the lower back of the user. The base body 80 may be hung on the hip region (an area of the hips) to prevent or reduce chances of the wearable device 100 from being separated downward due to gravity while the user is wearing the wearable device 100. The base body 80 may distribute a portion of a weight of the wearable device 100 to the lower back of the user while the user is wearing the wearable device 100. The base body 80 may be connected to the waist support frame 20. Waist support frame connecting elements (not shown) to be connected to the waist support frame 20 may be provided at both end portions of the base body 80.

In an embodiment, the lighting unit 85 may be provided on the outer surface of the base body 80. The lighting unit 85 may include a light source (e.g., a light-emitting diode (LED)). The lighting unit 85 may emit light in response to a control of a processor (not shown) (e.g., a processor 512 of FIG. 5) of the wearable device 100. In some embodiments, the lighting unit 85 may be controlled to provide (or output) visual feedback corresponding to the state of the wearable device 100 through the lighting unit 85.

In an embodiment, a display (not shown) may be provided on the outer surface of the base body 80. The display may provide a screen for various pieces of visual information related to the wearable device 100 (e.g., state information of the wearable device 100) and a user interface (UI).

The waist support frame 20 may support a body part (e.g., the waist) of the user when the wearable device 100 is worn on the body of the user. The waist support frame 20 may extend from both end portions of the base body 80. The lumbar region of the user may be accommodated inside the waist support frame 20. The waist support frame 20 may include at least one rigid body beam. Each beam may be in a curved shape having a preset curvature to enclose the lumbar region of the user. The waist fastener 60 may be connected to an end portion of the waist support frame 20. The first driving module 45 and the second driving module 35 may be directly or indirectly connected to the waist support frame 20.

In an embodiment, a processor, a memory (e.g., a memory 514 of FIG. 5), an IMU (e.g., the IMU 135 of FIG. 1 or an IMU 522 of FIG. 5), a communication circuit (e.g., a communication circuit 516 of FIG. 5), a sound output circuit (e.g., the sound output circuit 550 of FIG. 5), and a battery (not shown) may be disposed in the base body 80. The base body 80 may protect the components disposed therein. The processor may generate a control signal for controlling the operation of the wearable device 100. The processor may control a motor (or an actuator) of each of the first driving module 45 and the second driving module 35 configured to generate torque based on electrical energy stored in the battery.

In an embodiment, the wearable device 100 may include one or more sensors. The wearable device 100 may include one or more sensors configured to obtain sensor data including motion information of the user and/or motion information of the components of the wearable device 100. For example, the one or more sensors may include an IMU (e.g., the IMU 135 of FIG. 1 or the IMU 522 of FIG. 5) configured to measure an upper body motion value of the user or a motion value of the waist support frame 20 and/or an angle sensor (e.g., the angle sensor 125 of FIG. 1 or a first angle sensor 524 and a second angle sensor 524-1 of FIG. 5) configured to measure a hip joint angle value of the user or a motion value of the torque transmission frame 50 or 55, but are not limited thereto. For example, the one or more sensors may further include at least one of a position sensor, a torque sensor, a pressure sensor, a temperature sensor, a biosignal sensor (e.g., a heart rate sensor or an electromyography sensor), a distance sensor, or a proximity sensor.

The waist fastener 60 may be connected, directly or indirectly, to the waist support frame 20 to fasten the waist support frame 20 to the waist of the user. The waist fastener 60 may include, for example, a pair of belts.

The first driving module 45 and the second driving module 35 may generate an external force (or torque) to be applied to the body of the user based on the control signal generated by the processor. For example, the first driving module 45 and the second driving module 35 may generate an assistance force or a resistance force applied to the legs of the user. In an embodiment, the first driving module 45 may be disposed at a position corresponding to the right hip joint of the user, and the second driving module 35 may be disposed at a position corresponding to the left hip joint of the user. The first driving module 45 may include a first actuator and a first joint member, and the second driving module 35 may include a second actuator and a second joint member. The first actuator may provide power to be transmitted to the first joint member, and the second actuator may provide power to be transmitted to the second joint member. The first actuator and the second actuator may each include a motor configured to generate power (or torque) by receiving power from the battery. When the motor is driven as the power is supplied thereto, the motor may generate a force (an assistance force) for assisting a body motion of the user or a force (a resistance force) for hindering a body motion of the user. In an embodiment, the processor may adjust the strength and direction of the force generated by the motor by adjusting a voltage and/or a current supplied to the motor.

In an embodiment, the first joint member and the second joint member may receive power from the first actuator and the second actuator, respectively, and apply an external force to the body of the user based on the received power. In an embodiment, the first joint member and the second joint member may be disposed at positions corresponding to the joints of the user, respectively. One side of the first joint member may be directly or indirectly connected to the first actuator, and the other side of the first joint member may be directly or indirectly connected to the first torque transmission frame 55. The first joint member may be rotated by the power received from the first actuator. An encoder or a Hall sensor that may operate as an angle sensor to measure a rotation angle (corresponding to a joint angle of the user) of the first joint member or the first torque transmission frame 55 may disposed on one side of the first joint member. One side of the second joint member may be connected to the second actuator, and the other side of the second joint member may be connected to the second torque transmission frame 50. The second joint member may be rotated by the power received from the second actuator. An encoder or a Hall sensor that may operate as an angle sensor to measure a rotation angle of the second joint member or the second torque transmission frame 50 may be disposed on one side of the second joint member.

In an embodiment, the first actuator may be disposed in a lateral direction of the first joint member, and the second actuator may be disposed in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, the embodiments are not limited thereto, and an actuator and a joint member may share a rotation axis. In an embodiment, each actuator may be spaced apart from a corresponding joint member. In this case, the driving module 35 or 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by the positional relationship between an actuator and a joint member and the power transmission structure described above.

In an embodiment, when the wearable device 100 is worn on the legs of the user, the first torque transmission frame 55 and the second torque transmission frame 50 may transmit torque generated by the first driving module 45 and the second driving module 35 to the body (e.g., the legs) of the user, respectively. The transmitted torque may act as an external force applied to the motions of the legs of the user. Respective end portions of the first torque transmission frame 55 and the second torque transmission frame 50 may be directly or indirectly connected to the joint member and rotate. As the other end portions of the first torque transmission frame 55 and the second torque transmission frame 50 are directly or indirectly connected to the first thigh fastener 2 and the second thigh fastener 1, the first torque transmission frame 55 and the second torque transmission frame 50 may transmit the torque generated by the first driving module 45 and the second driving module 35 to the user's thighs while supporting the user's thighs. For example, the first torque transmission frame 55 and the second torque transmission frame 50 may push or pull the thighs of the user. The first torque transmission frame 55 and the second torque transmission frame 50 may extend in a longitudinal direction of the thighs of the user or may be bent and enclose at least some portions of the circumferences of the thighs of the user. The first torque transmission frame 55 may be a torque transmission frame for transmitting torque to the right leg of the user, and the second torque transmission frame 50 may be a torque transmission frame for transmitting torque to the left leg of the user.

The first thigh fastener 2 and the second thigh fastener 1 may be directly or indirectly connected to the first torque transmission frame 55 and the second torque transmission frame 50, respectively, and may fasten the wearable device 100 to the legs (specifically, thighs) of the user. The first thigh fastener 2 may be a thigh fastener for fastening the wearable device 100 to the right thigh of the user, and the second thigh fastener 1 may be a thigh fastener for fastening the wearable device 100 to the left thigh of the user.

In an embodiment, the first thigh fastener 2 may include a first cover, a first fastening frame, and a first strap, and the second thigh fastener 1 may include a second cover, a second fastening frame, and a second strap. The first cover and the second cover may apply torque generated by the first driving module 45 and the second driving module 35 to the thighs of the user, respectively. The first cover and the second cover may be disposed on respective sides of the thighs of the user and push or pull the thighs of the user, respectively. The first cover and the second cover may be arranged in circumferential directions of the thighs of the user. The first cover and the second cover may extend to both sides from the other end portions of the first torque transmission frame 55 and the second torque transmission frame 50, and may include curved surfaces corresponding to the thighs of the user. The respective ends of the first cover and the second cover may be directly or indirectly connected to the first fastening frame and the second fastening frame. The other ends of the first cover and the second cover may be directly or indirectly connected to the first strap and the second strap.

For example, the first fastening frame and the second fastening frame may be disposed to enclose at least some portions of the circumferences of the thighs of the user, thereby the thighs of the user may be prevented from being separated from the wearable device 100 or a possibility of separation may be reduced. The first fastening frame may have a fastening structure that connects the first cover to the first strap, and the second fastening frame may have a fastening structure that connects the second cover to the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first strap and the second strap may include, for example, an elastic material (e.g., a band).

FIG. 5 is a diagram illustrating components of a wearable device according to various embodiments.

Referring to FIG. 5, the wearable device 100 may include a control circuit 510, a communication circuit 516, one or more sensors (e.g., an IMU 522, a first angle sensor 524, and a second angle sensor 524-1), driving modules 530 and 530-1, an input circuit 540, a sound output circuit 550 including a speaker, and a haptic circuit 560.

The driving module 530 may include a motor 534 and a motor driver circuit 532 for driving the motor 534, and the driving module 530-1 may include a motor 534-1 and a motor driver circuit 532-1 for driving the motor 534-1. Although the embodiment of FIG. 5 shows two driving modules, this is merely an example, and one driving module or three or more driving modules may be provided. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3.

The one or more sensors may include one or more sensors configured to obtain sensor data (or sensed values). The one or more sensors may transmit the obtained sensor data to the control circuit 510. The one or more sensors may include, for example, the IMU 522, the first angle sensor 524, and/or the second angle sensor 524-1. Each of the sensors may be provided in plurality, and a portion of the sensors may be omitted.

The IMU 522 may measure a motion value of the body of the user. The IMU 522 may sense X-axis, Y-axis, and Z-axis accelerations and X-axis, Y-axis, and Z-axis angular velocities according to a motion of the user. The IMU 522 may measure, for example, an upper body motion value of the user. The upper body motion value of the user may correspond to a motion value of a waist support frame (e.g., the waist support frame 20 of FIGS. 3 and 4) of the wearable device 100. In an embodiment, the IMU 522 may be disposed on a printed circuit board (PCB) in the base body 80 of the wearable device 100, and may measure a signal indicating the degree of tilting of the wearable device 100 and/or the acceleration of the wearable device 100.

The first angle sensor 524 and the second angle sensor 524-1 may measure hip joint angles according to the leg motion of the user. The first angle sensor 524 may sense the hip joint angle of the right leg of the user, and the second angle sensor 524-1 may sense the hip joint angle of the left leg of the user. Each of the first angle sensor 524 and the second angle sensor 524-1 may include, for example, an encoder and/or a Hall sensor. The hip joint angle of the right leg sensed by the first angle sensor 524 may correspond to a motion value (e.g., rotation angle value) of a first torque transmission frame (e.g., the first torque transmission frame 55 of FIG. 3) of the wearable device, and the hip joint angle of the left leg sensed by the second angle sensor 524-1 may correspond to a motion value (e.g., rotation angle value) of a second torque transmission frame (e.g., the second torque transmission frame 50 of FIG. 3) of the wearable device.

In an embodiment, the one or more sensors may further include a torque sensor configured to sense a torque value, a position sensor configured to obtain a position value of the wearable device 100, a proximity sensor configured to detect the proximity of an object, a biosignal sensor configured to detect a biosignal of a user, a distance sensor configured to measure the distance to an object, a pressure sensor configured to measure a pressure value, and/or a temperature sensor configured to measure ambient temperature.

The input circuit 540 may receive a command or data to be used by a component (e.g., the processor 512) of the wearable device 100 from the outside (e.g., the user) of the wearable device 100. The input circuit 540 may include, for example, a key (e.g., a button) and/or a touch screen.

The sound output circuit 550 may output a sound signal to the outside of the wearable device 100. The sound output circuit 550 may include a speaker that plays a guide sound signal (e.g., a driving start sound or an operation error notification sound), music content, or a guiding voice.

In an embodiment, the wearable device 100 may further include a battery (not shown) configured to supply power to each component of the wearable device 100 and a power management circuit (not shown) configured to control the power supply. The wearable device 100 may convert the power of the battery into power suitable for an operating voltage of each component of the wearable device 100 and supply the converted power to each component.

The driving modules 530 and 530-1 may generate external force to be applied to the legs of the user under the control of the control circuit 510. The driving modules 530 and 530-1 may be disposed in positions corresponding to the positions of the hip joints of the user, and may generate torque to be applied to the legs of the user based on a control signal generated by the control circuit 510. The control circuit 510 may transmit the control signal to the motor driver circuits 532 and 532-1, and the motor driver circuits 532 and 532-1 may control the operation of the motors 534 and 534-1 by generating a current signal (or a voltage signal) corresponding to the control signal and supplying the current signal (or the voltage signal) to the motors 534 and 534-1. The current signal may not be supplied to the motors 534 and 534-1 according to the control signal. When the motors 534 and 534-1 are driven as the current signal is supplied to the motors 534 and 534-1, the motors 534 and 534-1 may generate assistance forces for assisting leg motions of the user or resistance forces for hindering leg motions of the user.

The control circuit 510 may control the overall operation of the wearable device 100, and generate a control signal to control each component of the wearable device 100. The control circuit 510 may include the processor 512 and the memory 514.

The processor 512 may execute, for example, software to control at least one other component (e.g., a hardware or software component) of the wearable device directly or indirectly connected to the processor 512, and perform a variety of data processing or computation. According to an embodiment, as at least part of data processing or computation, the processor 512 may store instructions or data received from another component (e.g., the communication circuit 516) in the memory 514, process the instructions or data stored in the memory 514, and store result data obtained as a result of processing in the memory 514. The processor 512 may include one or more processors, and the operations of the wearable device 100 described in the disclosure may be performed by one processor or by a combination of multiple processors.

According to an embodiment, the processor 512 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor. The processor 512 may be implemented as a system on chip (SoC) or an integrated circuit (IC) configured to perform processing. The auxiliary processor may be implemented separately from the main processor or as a part of the main processor. Thus, each “processor” herein may comprise one or more processors, each including processing circuitry.

The memory 514 may store a variety of data used by at least one component (e.g., the processor 512) of the control circuit 510. The data may include, for example, software, sensor data, and input data or output data for instructions related thereto. The memory 514 may include at least one instruction executable by the processor 512. The memory 514 may include one or more memories, and the instructions controlled by the processor 512 to perform the operations of the wearable device 100 described herein may be stored in one memory or divided and stored in multiple memories. The memory 514 may include a volatile memory or a non-volatile memory.

The communication circuit 516 may support establishing a direct (e.g., wired) communication channel or a wireless communication channel between the control circuit 510 and another component of the wearable device 100 or an external electronic device (e.g., the electronic device 210 or the other wearable device 220 of FIG. 2) and performing communication via the established communication channel. For example, the communication circuit 516 may transmit the sensor data obtained by the sensor to an external electronic device (e.g., the electronic device 210 of FIG. 2) and receive a control signal from the external electronic device. According to an embodiment, the communication circuit 516 may include one or more CPs that operate independently of the processor 512 and support direct (e.g., wired) communication or wireless communication. According to an embodiment, the communication circuit 516 may include a wireless communication circuit (e.g., a cellular communication circuit, a short-range wireless communication circuit, or a global navigation satellite system (GNSS) communication circuit), and/or a wired communication circuit. The wireless communication circuit may communicate with another component of the wearable device 100 and/or an external device via, for example, Bluetooth™, wireless fidelity (Wi-Fi), advanced and adaptive network technology (ANT), infrared data association (IrDA), a legacy cellular network, a 5G network, a next-generation network, the Internet, or a computer network (e.g., a local area network (LAN) or a wide area network (WAN)).

The haptic circuit 560 may provide haptic feedback to the user under the control of the processor 512. The haptic circuit 560 may include one or a plurality of haptic actuators. The haptic actuator may include, for example, a piezo actuator, a bander type actuator, and/or a vibration motor-based actuator. One or a plurality of haptic actuators may be provided. In an embodiment, the haptic actuator may be disposed in at least one of a base body (e.g., the base body 80 of FIG. 3), a torque transmission frame (e.g., the first torque transmission frame 55 or the second torque transmission frame 50 of FIG. 3), and a thigh fastener (e.g., the first thigh fastener 2 or the second thigh fastener 1 of FIG. 3) of the wearable device 100.

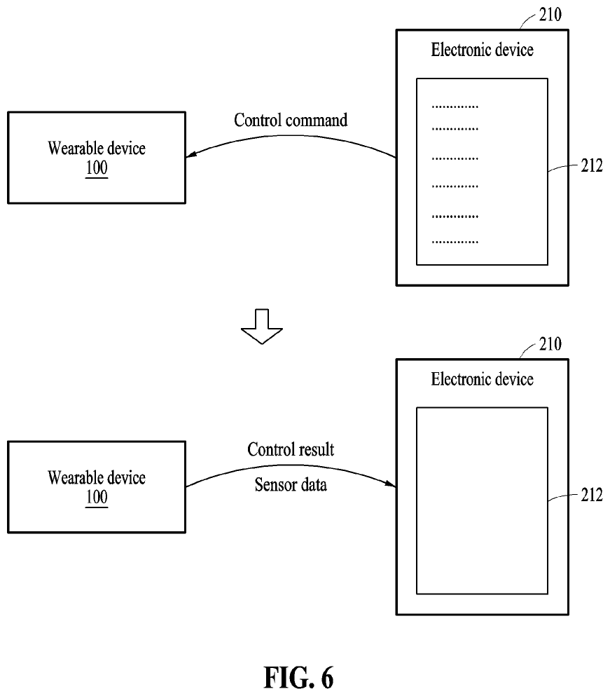

FIG. 6 is a diagram illustrating an interaction between a wearable device and an electronic device according to various embodiments.

Referring to FIG. 6, the wearable device 100 may communicate with the electronic device 210. For example, the electronic device 210 may be a user terminal of a user who uses the wearable device 100. In an embodiment, the wearable device 100 and the electronic device 210 may be connected to each other via short-range wireless communication (e.g., Bluetooth TM or Wi-Fi communication).

In an embodiment, the electronic device 210 may check a state of the wearable device 100 or execute an application to control or operate the wearable device 100. A screen of a UI may be displayed to control an operation of the wearable device 100 or determine an operating mode of the wearable device 100 on a display 212 of the electronic device 210 through the execution of the application. The UI may be, for example, a GUI.

In an embodiment, the user may input an instruction for controlling the operation of the wearable device 100 (e.g., an execution instruction to a walking assistance mode or an exercise assistance mode) or change settings of the wearable device 100 through a GUI screen on the display 212 of the electronic device 210. Further, the user may set exercise goals and change a torque parameter to be applied to the wearable device 100 through the GUI screen. The torque parameter may include, for example, a first parameter to control the magnitude of torque generated by a motor (e.g., the motor 534 or the motor 534-1 of FIG. 5) of the wearable device 100 and/or a second parameter to control a point in time when the torque is applied. In various embodiments of the present disclosure, the term “torque parameter” may be replaced with the term “parameter”, “robot parameter”, or “control parameter”.

The electronic device 210 may generate a control command (or control signal) corresponding to an operation control command or a setting change command input by the user and transmit the generated control command to the wearable device 100. In an embodiment, the torque parameter set by the user may be included in the control command. The wearable device 100 may operate according to the received control command and may transmit a control result according to the received control command and/or sensor data sensed by a sensor module of the wearable device 100 to the electronic device 210. The electronic device 210 may provide the user with result information (e.g., current exercise state information, exercise result information, exercise posture assessment information, and physical ability assessment information) derived by analyzing the control result and/or the sensor data through the GUI screen.

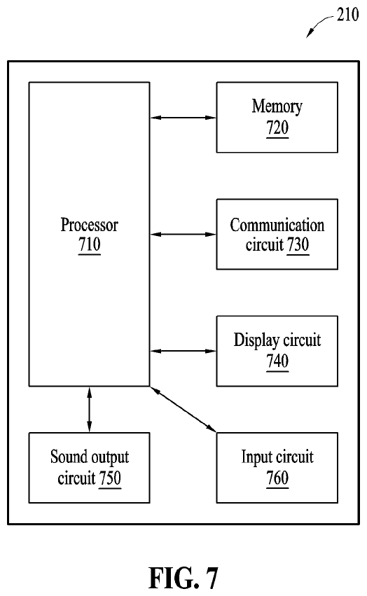

FIG. 7 is a diagram illustrating components of an electronic device according to various embodiments.

Referring to FIG. 7, the electronic device 210 may include a processor 710, a memory 720, a communication circuit 730, a display circuit 740, a sound output circuit 750, and an input circuit 760. In an embodiment, at least one (e.g., the sound output circuit 750) of these components may be omitted from the electronic device 210, or one or more other components (e.g., a sensor circuit, a haptic circuit, and a battery) may be added thereto.

The processor 710 may control at least one other component (e.g., a hardware or software component) of the electronic device 210 and may perform a variety of data processing or computation. According to an embodiment, as at least part of data processing or computation, the processor 710 may store instructions or data received from another component (e.g., the communication circuit 730) in the memory 720, process the instructions or data stored in the memory 720, and store result data in the memory 720. The processor 710 may include one or more processors, and the operations of the electronic device 210 described in the disclosure may be performed by one processor or by a combination of multiple processors.

In an embodiment, the processor 710 may include at least one of a main processor (e.g., a CPU or an AP) or an auxiliary processor (e.g., a GPU, an NPU, an ISP, a sensor hub processor, or a CP) that is operable independently of or in conjunction with the main processor. The processor 710 may be implemented as an SoC or an IC configured to perform processing.

The memory 720 may store a variety of data used by at least one component (e.g., the processor 710 or the communication circuit 730) of the electronic device 210. The data may include, for example, a program (e.g., an application) and input data or output data for an instruction related thereto. The memory 720 may include at least one instruction executable by the processor 710. The memory 720 may include one or more memories, and the instructions controlled by the processor 710 to perform the operations of the electronic device 210 described herein may be stored in one memory or divided and stored in multiple memories. The memory 720 may include a volatile memory or a non-volatile memory.

The communication circuit 730 may support establishing a direct (e.g., wired) communication channel or a wireless communication channel between the electronic device 210 and another electronic device (e.g., the wearable device 100, the other wearable devices 220, and the server 230), and performing communication via the established communication channel. The communication circuit 730 may include a communication circuit configured to perform a communication function. The communication circuit 730 may include one or more CPs that are operable independently of the processor 710 (e.g., an AP) and that support a direct (e.g., wired) communication or a wireless communication. According to an embodiment, the communication circuit 730 may include a wireless communication circuit configured to perform wireless communication (e.g., a Bluetooth communication circuit, a cellular communication circuit, a Wi-Fi communication circuit, or a GNSS communication circuit) or a wired communication circuit (e.g., a LAN communication circuit or a power line communication (PLC) circuit). For example, the communication circuit 730 may transmit a control command to the wearable device 100 and receive, from the wearable device 100, at least one of sensor data including body motion information of a user who is wearing the wearable device 100, state data of the wearable device 100, or control result data corresponding to the control command.

The display circuit 740 may visually provide information to the outside (e.g., the user) of the electronic device 210. The display circuit 740 may include, for example, a liquid-crystal display (LCD) or organic light-emitting diode (OLED) display, a hologram device, or a projector device. The display circuit 740 may further include a control circuit configured to control the driving of a display. In an embodiment, the display circuit 740 may further include a touch sensor configured to sense a touch or a pressure sensor configured to measure the magnitude of force generated by the touch. The display circuit 740 may output a UI screen to control the wearable device 100 or provide various pieces of information (e.g., exercise evaluation information or setting information of the wearable device 100).

The sound output circuit 750 may output sound signals to the outside of the electronic device 210. The sound output circuit 750 may include a guide sound signal (e.g., a driving start sound or an operation error notification sound) based on a state of the wearable device 100 and a speaker for playing musical content or a guide voice.

The input circuit 760 may receive, from the outside (e.g., the user) of the electronic device 210, a command or data to be used by a component (e.g., the processor 710) of the electronic device 210. The input circuit 760 may include an input component circuit and receive a user input. The input circuit 760 may include, for example, a touch recognition circuit for recognizing a touch on a key (e.g., a button) and/or a screen.

In an embodiment, the electronic device 210 may control driving of the wearable device 100 based on exercise data of a user. The electronic device 210 may not only measure an exercise ability and an exercise state of a user who exercises using the wearable device 100 but also directly provide an exercise intensity to be applied to the exercise of the user. The provision of the exercise intensity may be implemented by controlling torque output from a motor (e.g., the motor 534 or the motor 534-1 of FIG. 5) of the wearable device 100.

When the user wears the wearable device 100 and performs an exercise (e.g., a walking exercise), the user may set an exercise goal through a UI provided by the electronic device 210. For example, the user may set at least one of an exercise type, a target walking speed, a target stride length, and a target exercise time, which are related to a target maximum or high heart rate. With respect to the exercise type, the user may select any one of a low-intensity exercise, a weight control exercise, an aerobic exercise, an anaerobic exercise, and a maximum heart rate exercise as the exercise type. The electronic device 210 may actively control the wearable device 100 to achieve the exercise goal set by the user. The electronic device 210 may control a torque parameter related to torque output from the motor of the wearable device 100 based on the exercise goal. The torque parameter may include a first parameter that adjusts a magnitude of the torque output from the motor and/or a second parameter that adjusts a point in time at which the torque is applied. As the magnitude of the torque increases according to the first parameter, the strength of a force received by the user may increase. According to the second parameter, a point in time at which the torque of the wearable device 100 is transmitted to the user or a response speed of the wearable device 100 may vary.

The electronic device 210 may automatically adjust the torque magnitude of the wearable device 100 and/or the point in time at which the torque is applied to achieve a target heart rate zone, a target stride length, and/or a target walking speed, which are defined in the exercise type set by the user. The electronic device 210 may determine a torque parameter of the wearable device 100 for each exercise section of an exercise performed by the user based on the exercise goal set by the user and may control torque output of the wearable device 100 based on the determined torque parameter. The torque magnitude or the point in time at which the torque is applied may vary for each exercise section. According to various embodiments described in the disclosure, the electronic device 210 may help efficiently achieve the exercise goal and may personalize driving of the wearable device 100 based on the exercise data of the user. As the user does not need to manually adjust the torque parameter of the wearable device 100 to achieve the exercise goal, user convenience may be improved.

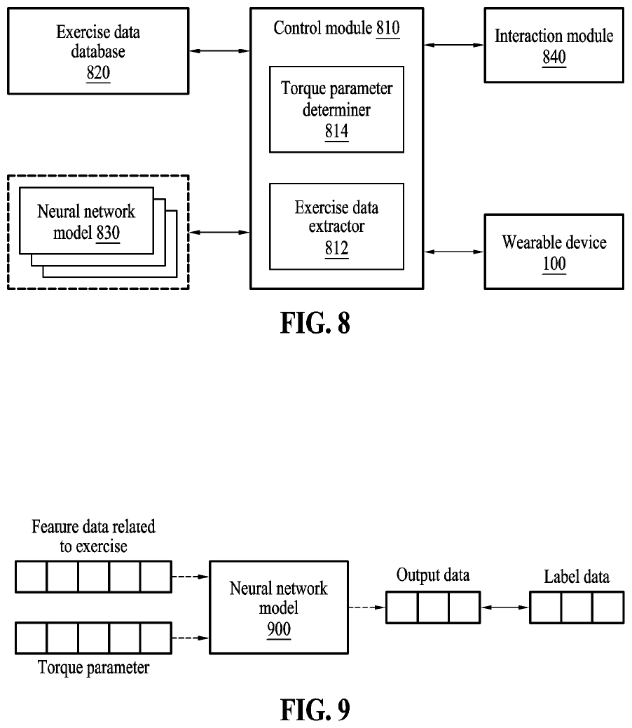

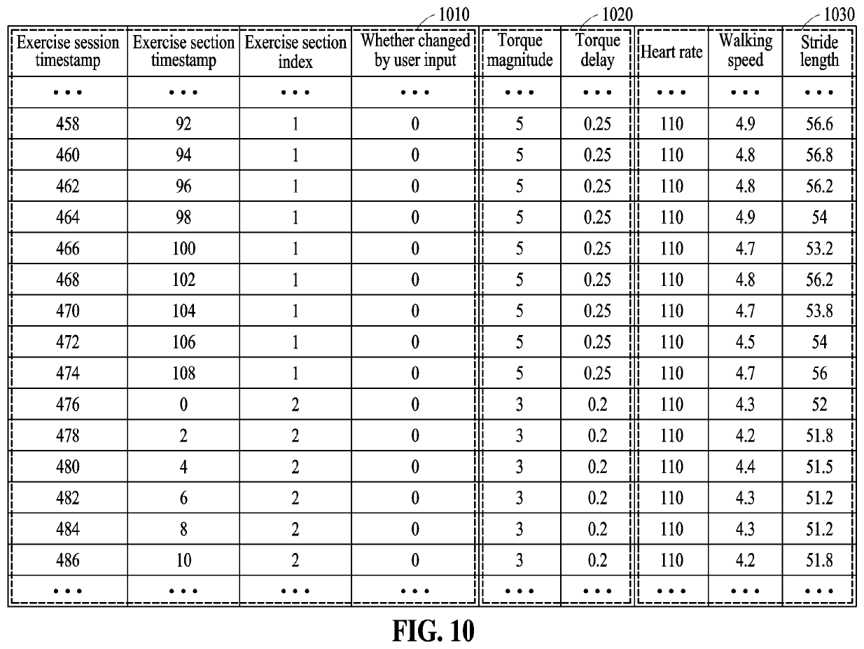

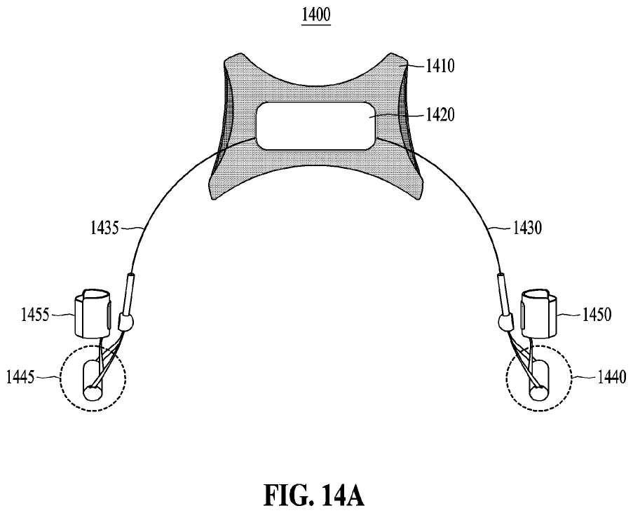

The electronic device 210, according to an embodiment, may include one or more processors 710, the input circuit 760 configured to receive a user input, and the communication circuit 730 configured to communicate with the wearable device 100. The electronic device 210 may provide the UI related to an exercise program to the user through a display included in the display circuit 740. The user may set an exercise type and/or an exercise goal through the UI. A user input (e.g., a touch input) for the exercise goal may be received through the input circuit 760. The one or more processors 710 may determine, in response to receiving a user input for an exercise goal through the input circuit 760, a torque parameter related to achievement of the exercise goal by using a neural network model (e.g., a neural network model 830 of FIG. 8, a neural network model 900 of FIG. 9, or a neural network model 1200 of FIG. 12) that receives, as an input, feature data related to an exercise performed by a user while wearing the wearable device 100 and outputs an estimated exercise performance indicator.

In an embodiment, the neural network model may be trained through a training process described below with reference to FIG. 9. The neural network model may be a model that has learned and modeled a relationship among exercise data of the user, a torque parameter of the wearable device 100, and an exercise performance indicator of the user. A torque parameter of the wearable device 100 for achieving the exercise goal may be determined by using the neural network model. Various neural network models may exist to be used for determining the torque parameter. For example, the neural network model may exist for each exercise type, each exercise difficulty, and/or each exercise section.

In an embodiment, the feature data related to an exercise input into the neural network model may include a feature value for an exercise section performed by the user (e.g., an exercise section timestamp or an exercise section index). The feature data related to the exercise may further include a feature value for at least one of an elapsed exercise time (e.g., an exercise session timestamp) and whether a torque parameter has been changed by a user input. The estimated exercise performance indicator, which is output data of the neural network model, may include, for example, at least one of a heart rate, a walking speed, and a stride length of the user. The neural network model may estimate an exercise performance indicator of the user based on the feature data related to the exercise, which is input data, and a torque parameter applied to the wearable device 100, and output the estimated exercise performance indicator.

In an embodiment, an exercise performed by the user may include a plurality of exercise sections. A period from a start to an end of the exercise may be defined as one exercise session, and one exercise session may include a plurality of exercise sections. A rest section of a certain period of time may exist between the exercise sections. Within one exercise section, a torque parameter applied to the wearable device 100 may be the same. Between the exercise sections, the torque parameters may be the same as or different from each other.

In an embodiment, the one or more processors 710 may determine a torque parameter to be applied to each exercise section by using the neural network model. Determining the torque parameter may be performed before a start of the exercise and/or in a rest section between the exercise sections. When one exercise section is completed, the one or more processors 710 may determine a torque parameter to be applied to a next exercise section in the rest section.

In an embodiment, when a first exercise section is completed, the one or more processors 710 may train the neural network model based on data collected up to the first exercise section and determine a torque parameter to be applied to a second exercise section, which is a next exercise section following the first exercise section, by using the trained neural network model.

The one or more processors 710 may estimate feature data related to an exercise for a next exercise section. The one or more processors 710 may estimate feature data for a next exercise section based on a feature value for exercise sections completed up to a current point. For example, an exercise session timestamp, an exercise section timestamp, and an exercise section index for a next exercise section may be estimated based on an exercise session timestamp, an exercise section timestamp, and an exercise section index that have been progressed up to the current point. The one or more processors 710 may input the feature data estimated for the next exercise section and a torque parameter corresponding to a reference value into the neural network model and obtain an estimated exercise performance indicator from the neural network model. Here, the torque parameter corresponding to the reference value may be, for example, a torque parameter of a predefined value. The one or more processors 710 may determine a torque parameter to be applied to the next exercise section based on the estimated exercise performance indicator obtained from the neural network model and an exercise goal indicator for achievement of the exercise goal. The exercise goal indicator is an indicator representing the exercise goal set by the user input. The exercise goal indicator may include, for example, a target maximum or high heart rate, a target walking speed, and/or a target stride length.

In an embodiment, the one or more processors 710 may search for a torque parameter with which a difference between the estimated exercise performance indicator obtained from the neural network model and the exercise goal indicator satisfies a set condition. The one or more processors 710 may set the difference between the estimated exercise performance indicator and the exercise goal indicator as a loss in machine learning and search for a torque parameter that minimizes or reduces the loss or a torque parameter that makes the loss equal to or less than a threshold.

In an embodiment, the one or more processors 710 may control the wearable device 100 to generate torque based on the determined torque parameter by causing the communication circuit 730 to transmit a control signal including the determined torque parameter to the wearable device 100. In response to having searched for a torque parameter with which the difference between the estimated exercise performance indicator obtained from the neural network model and the exercise goal indicator satisfies the set condition, the one or more processors 710 may control the communication circuit 730 to transmit a control signal including the searched-for torque parameter to the wearable device 100 such that the wearable device 100 generates torque based on the searched-for torque parameter in a next exercise section.

In an embodiment, when an entire exercise section of the exercise is completed, training (machine learning) on the neural network model may be performed based on sensor data collected during performance of the exercise, a torque parameter applied during the exercise performance, and feature data related to the exercise. When the entire exercise section of the exercise is completed, the one or more processors 710 may update a model parameter of the neural network model based on an exercise performance indicator measured based on sensor data collected during the performance of the exercise and the estimated exercise performance indicator output from the neural network model. Training (machine learning) on the neural network model may be performed based on sensor data collected during the performance of the exercise, a torque parameter applied during the exercise performance, and feature data related to the exercise.

The sensor data collected during the performance of the exercise may include, for example, a heart rate of the user measured through a heart rate sensor, a hip joint angle value measured by an angle sensor (e.g., the first angle sensor 524 or the second angle sensor 524-1 of FIG. 5) of the wearable device 100, and/or a motion value measured by an IMU 522 of the wearable device 100. The one or more processors 710 may measure a maximum heart rate of the user based on the heart rate measured through the heart rate sensor. The heart rate sensor may be provided in, for example, a smartwatch (e.g., the smartwatch 224 of FIG. 2) and/or the wearable device 100. The one or more processors 710 may measure a walking speed and/or a stride length of the user based on the hip joint angle value measured through the angle sensor of the wearable device 100. The one or more processors 710 may measure a walking speed of the user based on the motion value measured through the IMU of the wearable device 100. The one or more processors 710 may use the exercise performance indicator measured based on the sensor data as label data of the machine learning. The one or more processors 710 may calculate a difference between the estimated exercise performance indicator output from the neural network model and the exercise performance indicator measured based on the sensor data as a loss and update a model parameter (e.g., a connection weight between artificial neurons or a bias) of the neural network model such that the calculated loss is minimized or reduced. Here, a back propagation algorithm that updates the model parameter based on the loss may be used. The trained neural network model may be stored and used as an initial neural network model to be used at a start of exercise when the user performs a next exercise. The initial neural network model may be used to determine a torque parameter to be applied to a first exercise section of the next exercise.

FIG. 8 is a diagram illustrating a system for controlling a wearable device based on exercise data of a user according to various embodiments.

Referring to FIG. 8, the system may include the wearable device 100, a control module 810, and an interaction module 840. The control module 810 may include an exercise data extractor 812 and a torque parameter determiner 814. The control module 810 is a module configured to control an exercise performed by the user and the wearable device 100, and may be implemented by a processor (e.g., the processor 710 of FIG. 7), memory (e.g., the memory 720 of FIG. 7), and a communication circuit (e.g., the communication circuit 730 of FIG. 7) of the electronic device 210. The interaction module 840 is a module configured to perform an interaction with the user, and may be implemented by a display circuit (e.g., the display circuit 740 of FIG. 7) and an input circuit (e.g., the input circuit 760 of FIG. 7) of the electronic device 210. An exercise data database 820 and a neural network model 830 may be stored in the electronic device 210 or stored in a device (e.g., the server 230 of FIG. 2) other than the electronic device 210.

The exercise data database 820 may store exercise data of the user. For example, the exercise data database 820 may store exercise data recording an exercise category performed by the user, an exercise type (e.g., a low-intensity exercise, a weight control exercise, an aerobic exercise, an anaerobic exercise, or a maximum heart rate exercise), an exercise time, an exercise intensity, a heart rate measured during performance of the exercise, a walking speed, and a stride length, but the types of exercise data stored therein are not limited thereto.

The neural network model 830 may be a machine learning model that has learned a relationship among exercise data. An operation of the neural network model 830 may be determined by a model parameter (e.g., a connection weight between artificial neurons or a bias) of the neural network model 830. The model parameter is a learnable parameter and may be determined through a machine learning process. Various neural network models may exist depending on the types of training data on which the neural network model 830 has been trained. For example, there may exist a neural network model trained based on entire accumulated exercise data of the user, a neural network model trained based on exercise data of the user during one day, a neural network model trained based on exercise data of the user during a specific time period, or a neural network model trained based on exercise data collected for each exercise type.

The control module 810 may control an overall operation of the wearable device 100. The exercise data extractor 812 of the control module 810 may extract exercise data of the user from sensor data obtained through a sensor of the wearable device 100 or a sensor of another device (e.g., the smartwatch 224 of FIG. 2). The exercise data extractor 812 may obtain data on the heart rate of the user based on the heart rate measured through a heart rate sensor. The exercise data extractor 812 may obtain data on the walking speed and/or the stride length of the user based on a hip joint angle value measured through an angle sensor (e.g., the first angle sensor 524 or the second angle sensor 524-1 of FIG. 5) of the wearable device 100. The exercise data extractor 812 may obtain data on the walking speed of the user based on a motion value measured through an IMU of the wearable device 100.

The torque parameter determiner 814 of the control module 810 may determine a torque parameter that determines a driving characteristic of the wearable device 100. The torque parameter may include a first parameter that controls a magnitude of torque output from a motor (e.g., the motor 534 or the motor 534-1 of FIG. 5) of the wearable device 100 and a second parameter that controls a point in time at which the torque is applied. The control module 810 may determine a torque parameter to be applied to the wearable device 100 by using the neural network model 830 according to the method described with reference to FIG. 7. The torque parameter determiner 814 may determine a torque parameter for each exercise section in accordance with the exercise goal of the user and transmit the torque parameter determined for each exercise section to the wearable device 100. Even when the user has not designated a specific torque parameter for each exercise section, the torque parameter determiner 814 may determine a torque parameter for achieving the exercise goal of the user for each exercise section and control the wearable device 100 in each exercise section based on the determined torque parameter. Between the exercise sections, the torque parameters may be the same as or different from each other.

The interaction module 840 may perform an interaction with the user. For example, the interaction module 840 may provide a UI screen to the user through a display and receive a user input. The user may set an exercise goal through the user input, and the interaction module 840 may show the user a torque parameter (the torque parameter determined by the torque parameter determiner 814) for achieving the set exercise goal through the UI screen. The user may adjust the torque parameter through the user input, and the interaction module 840 may transmit the torque parameter adjusted by the user input to the torque parameter determiner 814. The torque parameter determiner 814 may control the wearable device 100 based on the torque parameter adjusted by the user input.

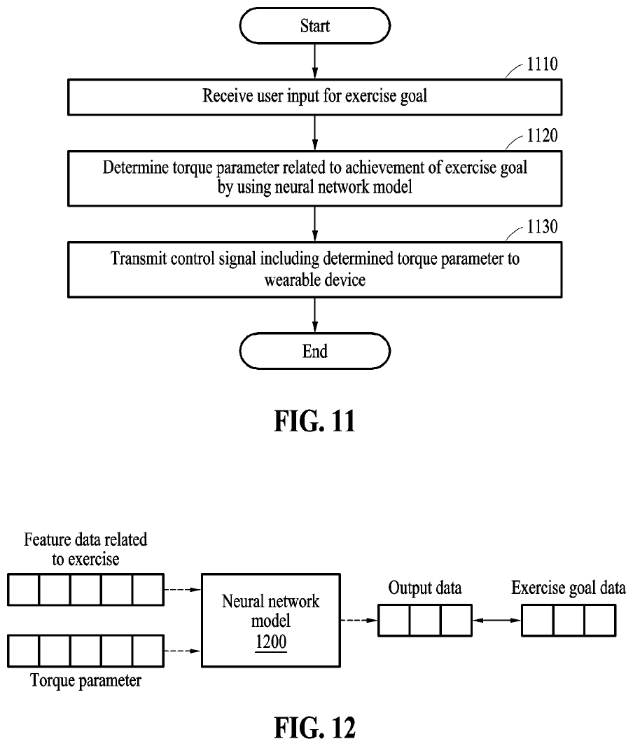

FIGS. 9 and 10 are diagrams illustrating input/output data and a training operation of a neural network model according to various embodiments.

Referring to FIG. 9, a neural network model 900 (e.g., the neural network model 830 of FIG. 8) may output an estimated exercise performance indicator of the user as output data when input data is input. The exercise performance indicator output from the neural network model 900 may not be an actually measured value but a value estimated based on the input data. The neural network model 900 may be a model designed to output an estimated value of an exercise performance indicator of the user when feature data related to an exercise and a torque parameter are input.

Input data of the neural network model 900 may include feature data related to an exercise and a torque parameter representing an operating characteristic of the wearable device 100. The feature data related to the exercise may be time-series data up to a specific time section. The feature data related to the exercise may include a timestamp-related feature value of the exercise performed by the user. For example, the feature data may include feature values for an exercise session timestamp and an exercise section timestamp. The exercise session timestamp represents an elapsed exercise time measured after a start of the exercise, and the exercise section timestamp represents an elapsed time of the exercise section measured after a start of the corresponding exercise section. The feature data related to the exercise may further include a feature value for at least one of an exercise section index and whether a torque parameter has been changed by a user input. The exercise section index represents an index (or an order) for the corresponding exercise section among entire exercise sections. The feature data related to the exercise may be composed of, for example, {an exercise session timestamp, an exercise section timestamp, an exercise section index, a value indicating whether a torque parameter has been changed by a user input}. The value indicating whether a torque parameter has been changed by a user input may be designated as, for example, ‘1’ when the user has changed the torque parameter through the user input and ‘0’ when the torque parameter has not been changed, but is not limited thereto. The torque parameter of the wearable device 100 input into the neural network model 900 may be a torque parameter (e.g., a parameter for a magnitude of torque or a parameter for a point in time at which the torque is applied) that has been applied to the wearable device 100 at the exercise section timestamp.

The neural network model 900 may estimate and output an exercise performance indicator of the user from the input data. The estimated exercise performance indicator may include, for example, at least one of a heart rate, a walking speed, and a stride length of the user.

An actual exercise performance indicator measured based on sensor data may be used as label data for the machine learning. The label data may be selected from, for example, exercise data extracted by the exercise data extractor 812 of FIG. 8. The label data may include data on a heart rate, a walking speed, and/or a stride length of the user measured based on the sensor data. The label data is used as ground truth in the machine learning.

An example of feature data related to an exercise, a torque parameter, and label data is illustrated in FIG. 10. Referring to FIG. 10, a table is illustrated showing data 1010 in which an exercise session timestamp, an exercise section timestamp, an exercise section index, and whether a torque parameter has been changed by a user input are collected, data 1020 in which a torque parameter of a torque magnitude and a torque delay that controls a point in time at which the torque is applied at each exercise session timestamp applied to the wearable device 100 are collected, and data 1030 in which a heart rate, a walking speed, and a stride length of the user at each exercise session timestamp measured based on sensor data are collected. Feature data related to an exercise for input into the neural network model 900 may be extracted from the data 1010, and a torque parameter for input into the neural network model 900 may be extracted from the data 1020. Label data to be compared with output data of the neural network model 900 may be extracted from the data 1030. Input data and output data of the neural network model 900 may be time-series data. For example, feature data related to an exercise in a specific time section and a torque parameter applied to the wearable device 100 in the specific time section may be used as input data for training of the neural network model 900, and an exercise performance indicator of the user measured in the corresponding specific time section may be used as label data.

A processor (e.g., the processor 710 of FIG. 7) of the electronic device 210 may train the neural network model 900 based on input/output data and label data of the neural network model 900. Through the training process, the neural network model 900 may learn, from exercise data of the user, how an exercise performance indicator of the user changes according to feature data related to the exercise and the torque parameter. Here, the exercise data may be time-series data obtained at a defined time period.

The neural network model 900 may estimate an exercise performance indicator yₚ^{t} of the user based on feature data x_{w}^{t} related to an exercise and a torque parameter xₚ^{t} given as training data at each time t. The processor may calculate a difference between the estimated exercise performance indicator yₚ^{t} output from the neural network model 900 and the measured exercise performance indicator Mₚ^{t} shown in the label data as a loss. For example, a mean squared error (MSE) between the estimated exercise performance indicator yₚ^{t} and the measured exercise performance indicator Mₚ^{t} may be calculated as the loss. The processor may continuously update a model parameter (e.g., a connection weight between artificial neurons or a bias) of the neural network model 900 in a direction in which the calculated loss decreases.

In an embodiment, the training process of the neural network model 900 as described above may be performed between the exercise sections or may be performed after the exercise is completed. When the training is performed between the exercise sections, the training may be performed based on exercise data collected up to a previous exercise section, and when the training is performed after the exercise is completed, the training may be performed based on exercise data collected during entire exercise sections. The trained neural network model 900 may be used to estimate a torque parameter to be applied to the wearable device 100 when the user performs a next exercise.

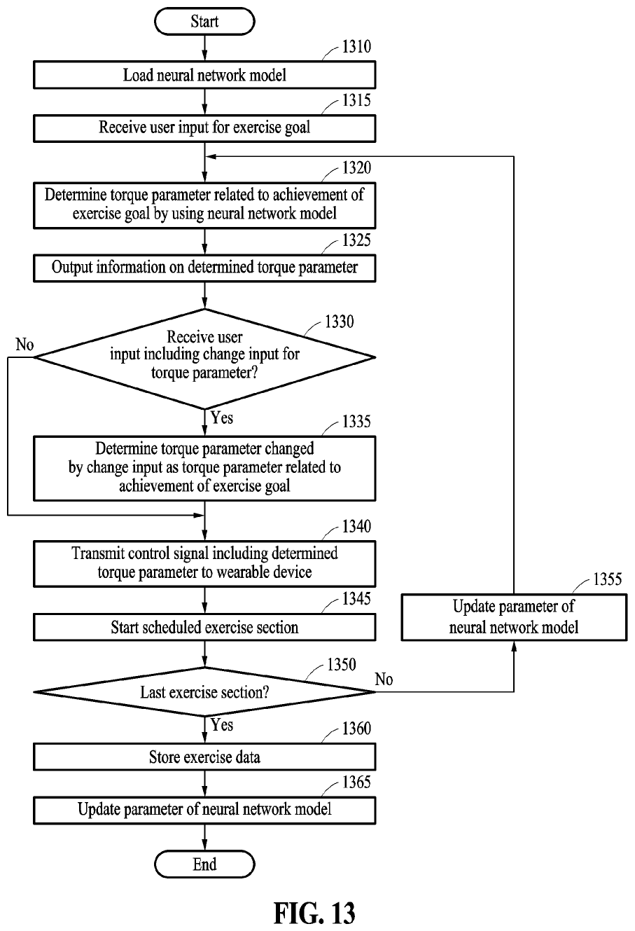

FIG. 11 is a flowchart illustrating operations of a control method of controlling a wearable device based on exercise data of a user according to various embodiments. In an embodiment, at least one of the operations of FIG. 11 may be performed simultaneously or in parallel with another operation, and an order of the operations may be changed. In addition, at least one of the operations may be omitted, or another operation may be additionally performed.

Referring to FIG. 11, in operation 1110, an input circuit (e.g., the input circuit 760 of FIG. 7) of the electronic device 210 may receive a user input for an exercise goal. The input circuit may receive a user input including a selection of at least one of, for example, an exercise type, a target walking speed, and a target stride length, which are related to a target maximum heart rate. The user may set or input an exercise goal through a UI screen provided through a display of the electronic device 210 before starting an exercise.

In operation 1120, a processor (e.g., the processor 710 of FIG. 7) of the electronic device 210 may determine a torque parameter related to achievement of the exercise goal by using a neural network model (e.g., the neural network model 830 of FIG. 8, the neural network model 900 of FIG. 9, or a neural network model 1200 of FIG. 12) that receives, as an input, feature data related to an exercise performed by the user while wearing the wearable device 100 and outputs an estimated exercise performance indicator. The neural network model may be a model that has learned and modeled a relationship among exercise data of the user, a torque parameter of the wearable device 100, and an exercise performance indicator of the user. A torque parameter of the wearable device 100 for achieving the exercise goal may be determined by using the neural network model. The processor may determine at least one of a first parameter that determines a magnitude of torque output from a motor (e.g., the motor 534 or the motor 534-1 of FIG. 5) of the wearable device 100 and a second parameter that determines a point in time at which the torque is applied.

In an embodiment, the feature data related to an exercise input into the neural network model may include a feature value for an exercise section performed by the user (e.g., an exercise section timestamp or an exercise section index). The feature data related to the exercise may further include a feature value for at least one of an elapsed exercise time (e.g., an exercise session timestamp) and whether a torque parameter has been changed by a user input. The estimated exercise performance indicator, which is output data of the neural network model, may include, for example, at least one of a heart rate, a walking speed, and a stride length of the user. The neural network model may estimate an exercise performance indicator of the user based on the feature data related to the exercise, which is input data, and a torque parameter applied to the wearable device 100, and output the estimated exercise performance indicator.

In an embodiment, an exercise performed by the user may include a plurality of exercise sections. In an embodiment, when a first exercise section is completed, the processor may train the neural network model based on data collected up to the first exercise section and determine a torque parameter to be applied to a second exercise section, which is a next exercise section following the first exercise section, by using the trained neural network model.

In an embodiment, the processor may estimate feature data related to an exercise for a next exercise section. The processor may estimate feature data for a next exercise section based on a feature value for exercise sections completed up to a current point. For example, an exercise session timestamp, an exercise section timestamp, and an exercise section index for a next exercise section may be estimated based on an exercise session timestamp, an exercise section timestamp, and an exercise section index that have been progressed up to the current point. The processor may input the feature data estimated for the next exercise section and a torque parameter corresponding to a reference value into the neural network model and obtain an estimated exercise performance indicator from the neural network model. Here, the torque parameter corresponding to the reference value may be, for example, a torque parameter of a predefined value. The processor may determine a torque parameter to be applied to the next exercise section based on the estimated exercise performance indicator obtained from the neural network model and an exercise goal indicator for achievement of the exercise goal. The exercise goal indicator may include, for example, a target maximum heart rate, a target walking speed, and/or a target stride length.

In an embodiment, the processor may search for a torque parameter with which a difference between the estimated exercise performance indicator obtained from the neural network model and the exercise goal indicator satisfies a set condition. The processor may set the difference between the estimated exercise performance indicator and the exercise goal indicator as a loss in machine learning and search for a torque parameter that minimizes or reduces the loss or a torque parameter that makes the loss equal to or less than a threshold.

In an embodiment, a display circuit (e.g., the display circuit 740 of FIG. 7) of the electronic device 210 may output information on the determined torque parameter. When the input circuit receives a user input including a change input for the torque parameter, the processor may, in response to receiving the user input, determine a torque parameter changed by the change input as the torque parameter related to achievement of the exercise goal.

In operation 1130, a communication circuit (e.g., the communication circuit 730 of FIG. 7) of the electronic device 210 may transmit a control signal including the determined torque parameter to the wearable device 100 under control of the processor such that the wearable device 100 generates torque based on the determined torque parameter.

In an embodiment, in response to having searched for a torque parameter with which the difference between the estimated exercise performance indicator obtained from the neural network model and the exercise goal indicator satisfies the set condition, the processor may control the communication circuit 730 to transmit a control signal including the searched-for torque parameter to the wearable device 100 such that the wearable device 100 generates torque based on the searched-for torque parameter in a next exercise section.

In an embodiment, when an entire exercise section of the exercise is completed, the processor may update a model parameter of the neural network model based on an exercise performance indicator measured based on sensor data collected during performance of the exercise and the estimated exercise performance indicator output from the neural network model. Training on the neural network model may be performed based on sensor data collected during the performance of the exercise, a torque parameter applied during the exercise performance, and feature data related to the exercise.

FIG. 12 is a diagram illustrating an operation of determining a torque parameter related to achievement of an exercise goal by using a neural network model according to various embodiments.

Referring to FIG. 12, a neural network model 1200 (e.g., the neural network model 830 of FIG. 8 or the neural network model 900 of FIG. 9) may output an estimated exercise performance indicator of the user as output data when input data is input. Input data of the neural network model 1200 may include feature data related to an exercise and a torque parameter representing an operating characteristic of the wearable device 100.

A processor (e.g., the processor 710 of FIG. 7) of the electronic device 210 may perform the following operations to search for a torque parameter that causes the neural network model 1200 to output an estimated exercise performance indicator that is the same as or similar to a target exercise performance indicator shown in exercise goal data of the user.

(1) The processor may estimate feature data related to an exercise for a next exercise section. In an embodiment, the processor may set feature data related to an exercise in the next exercise section to an exercise session timestamp, an exercise section timestamp, and an exercise section index expected in the next exercise section.

(2) The processor may set a torque parameter in the next exercise section to be input into the neural network model 1200 to a torque parameter corresponding to a reference value. For example, the torque parameter to be input into the neural network model 1200 may be set to a value of ‘0’. Within one exercise section, the torque parameter may be set to be the same over time.

(3) The processor may input the feature data related to the exercise set in (1) and the torque parameter set in (2) into the neural network model 1200 and obtain an estimated exercise performance indicator (e.g., a maximum heart rate, a walking speed, or a stride length) as output data of the neural network model 1200. The neural network model 1200 may estimate the exercise performance indicator through feed-forward computation.

(4) The processor sets exercise goal data based on the exercise goal of the user. The exercise goal data may include, for example, a target maximum heart rate, a target walking speed, and/or a target stride length.

(5) The processor may calculate a difference between the estimated exercise performance indicator obtained from the output data of the neural network model 1200 and the exercise goal indicator shown in the exercise goal data as a loss of the machine learning. For example, a difference between a maximum heart rate estimated by the neural network model 1200 and a target maximum heart rate of the user, a difference between a walking speed estimated by the neural network model 1200 and a target walking speed of the user, and a difference between a stride length estimated by the neural network model 1200 and a target stride length of the user may be calculated as the loss.

(6) The processor may determine whether the loss calculated in (5) is equal to or less than a threshold. If the loss is not equal to or less than the threshold, the processor may perform the following operation (7).

(7) The processor may search for a torque parameter that minimizes or reduces the calculated loss. In an embodiment, the processor may search for a torque parameter that minimizes the loss by using a gradient descent algorithm based on a partial derivative of the loss with respect to the torque parameter. During the searching process, a model parameter of the neural network model 1200 is not updated.

(8) The processor may transmit a control signal including the torque parameter searched for in (7) to the wearable device 100 through a communication circuit (e.g., the communication circuit 730 of FIG. 7) of the electronic device 210. The wearable device 100 may control output of the torque based on the torque parameter included in the control signal.

(9) For a next exercise section, the processor may perform the processes (1) through (8) described above again.

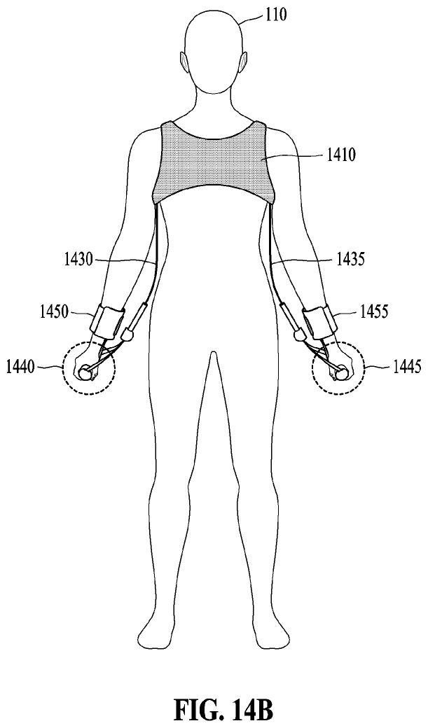

FIG. 13 is a flowchart illustrating operations of a control method of controlling a wearable device based on exercise data of a user according to various embodiments. In an embodiment, at least one of the operations of FIG. 13 may be performed simultaneously or in parallel with another operation, and an order of the operations may be changed. In addition, at least one of the operations may be omitted, or another operation may be additionally performed.

Referring to FIG. 13, in operation 1310, a processor (e.g., the processor 710 of FIG. 7) of the electronic device 210 may load a neural network model (e.g., the neural network model 830 of FIG. 8, the neural network model 900 of FIG. 9, or the neural network model 1200 of FIG. 12). If a previously trained neural network model exists, the trained neural network model may be loaded, and if no previously trained neural network model exists, a neural network model operating with a default model parameter may be loaded. The previously trained neural network model may be, for example, a neural network model trained based on exercise data of the user according to the training process described with reference to FIG. 9.

In operation 1315, an input circuit (e.g., the input circuit 760 of FIG. 7) of the electronic device 210 may receive a user input for an exercise goal. The user may set an exercise goal for a current exercise through the user input. With respect to the exercise goal, the user may select an exercise type related to a maximum heart rate. In an embodiment, when the age of the user is given, a reference maximum heart rate corresponding to the age of the user may be determined, and various exercise types may be presented based on the determined reference maximum heart rate. For example, a low-intensity exercise may have an exercise goal in which the maximum heart rate of the user falls within a heart rate zone corresponding to 50-60% of the reference maximum heart rate, and a weight control exercise may have an exercise goal in which the maximum heart rate of the user falls within a heart rate zone corresponding to 60-70% of the reference maximum heart rate. An aerobic exercise may have an exercise goal in which the maximum heart rate of the user falls within a heart rate zone corresponding to 70-80% of the reference maximum heart rate, and an anaerobic exercise may have an exercise goal in which the maximum heart rate of the user falls within a heart rate zone corresponding to 80-90% of the reference maximum heart rate. A maximum heart rate exercise may have an exercise goal in which the maximum heart rate of the user falls within a heart rate zone corresponding to 90-100% of the reference maximum heart rate. For example, if the reference maximum heart rate of the user is 220 and the user has selected the exercise type of the anaerobic exercise, the target maximum heart rate may be set to between 176 and 198.

In an embodiment, the user may also set an exercise goal of a target walking speed and/or a target stride length with respect to a walking exercise. The user may select, for example, any one of a target walking speed that is slower than a reference walking speed, a target walking speed that corresponds to the reference walking speed, and a target walking speed that is faster than the reference walking speed as the target walking speed. The reference walking speed may correspond to, for example, an average value of measured values of the walking speed of the user collected over time. The user may also select any one of a target stride length that is narrower than a reference stride length, a target stride length that corresponds to the reference stride length, and a target stride length that is wider than the reference stride length as the target stride length. The reference stride length may correspond to, for example, an average value of measured values of the stride length of the user collected over time.

In operation 1320, the processor may determine a torque parameter related to achievement of the exercise goal by using a neural network model (e.g., the neural network model 830 of FIG. 8, the neural network model 900 of FIG. 9, or the neural network model 1200 of FIG. 12). The processor may determine the torque parameter by using the neural network model according to the process as described with reference to FIG. 12. The processor may iteratively perform estimation of a torque parameter that is able to achieve the exercise goal of the user by using the neural network model.

In operation 1325, a display circuit (e.g., the display circuit 740 of FIG. 7) of the electronic device 210 may output information on the determined torque parameter. The electronic device 210 may estimate a torque parameter that is able to satisfy the exercise goal of the user by using the neural network model and then provide feedback on the estimated torque parameter to the user. In an embodiment, the user may directly change the torque parameter through the UI screen if desired.

In operation 1330, the processor may determine whether a user input including a change input for the torque parameter has been received through the input circuit.

When it is determined that the user input including the change input has been received (‘Yes’ in operation 1330), in operation 1335, the processor may determine a torque parameter changed by the change input as the torque parameter related to achievement of the exercise goal.

In operation 1340, a communication circuit (e.g., the communication circuit 730 of FIG. 7) of the electronic device 210 may transmit a control signal including the determined torque parameter to the wearable device 100 under control of the processor such that the wearable device 100 generates torque based on the determined torque parameter.

In operation 1345, the processor and the wearable device 100 may start a scheduled exercise section. If no exercise section has been previously performed, a first exercise section may be started, and if an exercise section has been previously performed, a next exercise section may be started. The wearable device 100 may control torque output based on the torque parameter received from the electronic device 210. The wearable device 100 may apply the torque parameter received from the electronic device 210 to a torque output of the motor and start the exercise section.

In operation 1350, the processor may determine whether a next exercise section is a last exercise section.

When it is determined that the next exercise section is not the last exercise section (‘No’ in operation 1350), in operation 1355, the processor may update a parameter of the neural network model. The processor may perform a training process on the neural network model based on exercise data obtained in a previous exercise section. For example, the processor may update the parameter of the neural network model for the exercise section by using exercise data collected in one or more exercise sections performed up to the current point among exercises performed today by the user. The training process on the neural network model may refer to the training process described with reference to FIG. 9.

When it is determined that the next exercise section is the last exercise section (‘Yes’ in operation 1350), in operation 1360, the processor may store exercise data collected up to the last exercise section after the last exercise section is ended. The collected exercise data may be stored in an exercise data database (e.g., the exercise data database 820 of FIG. 8).

In operation 1365, the processor may update the parameter of the neural network model based on the exercise data stored in operation 1360. The processor may train the neural network model based on exercise data collected during entire exercise sections performed today. The processor may store the model parameter of the trained neural network model after training on the neural network model is completed. The trained neural network model may be used as an initial neural network model at a start of a next exercise.

In an embodiment, the neural network model trained in operation 1355 and the neural network model trained in operation 1365 may be different from each other. The neural network model trained in operation 1355 may be a neural network model trained based on exercise data collected in the exercise section, and the neural network model trained in operation 1365 may be a neural network model trained based on entire exercise data of the user.

In various embodiments described in the disclosure, operations of determining a torque parameter of the wearable device 100 may be performed not only by the electronic device 210 but also by a processor (e.g., the processor 512 of FIG. 5) of the wearable device 100.

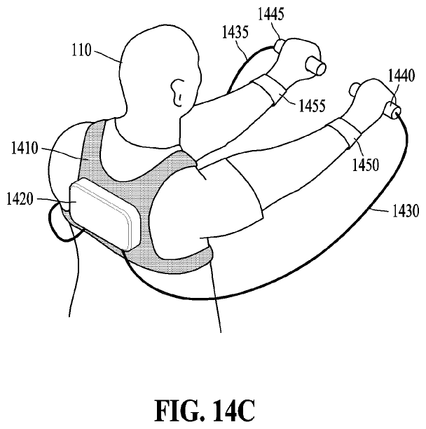

FIGS. 14A, 14B, and 14C are diagrams illustrating a cable-based wearable device and determining a torque parameter for the cable-based wearable device according to various embodiments.

The wearable device controlled by the electronic device 210 may vary. For example, there may be a hip-type wearable device 100 capable of assisting the legs as illustrated in FIGS. 1, 2, 3, and 4, and there may be a cable-based wearable device 1400 worn on an upper body of a user as illustrated in FIGS. 14A, 14B, and 14C.

Referring to FIGS. 14A, 14B, and 14C, the wearable device 1400 may be worn on the upper body (the torso, the waist, the arms, the wrists, the hands, etc.) of a user 110 to apply an external force of a resistance force to a body motion of the user 110. In an example embodiment, the wearable device 1400 may apply a resistance force to a body motion of the user 110 by adjusting tension of a cable 1430 or 1435 connected, directly or indirectly, to a body coupling component 1440 or 1445 held by a hand of the user 110. The tension of the cable 1430 or 1435 represents a force applied to the cable 1430 or 1435 by a force (e.g., torque) generated by a motor of the wearable device 1400.

In an example embodiment, the wearable device 1400 may operate in an exercise posture guide mode that guides an exercise posture of the user 110. In the exercise posture guide mode, the wearable device 1400 may estimate a position of the body coupling component 1440 or 1445 of the wearable device 1400 and may adjust the tension of the cable 1430 or 1435 based on the position of the body coupling component 1440 or 1445. The wearable device 1400 may estimate that the position of the body coupling component 1440 or 1445 to be the position of the hand of the user 110 and may determine whether the position of the hand of the user (or a change in the position of the user's hand over time) corresponds to an intended exercise posture. The body coupling component 1440 or 1445 may be a component for connecting or fixing the cable 1430 or 1435 to a portion of the body of the user 110. The body coupling component 1440 or 1445 may be, for example, in a form of a handle, a band, a frame, a bracelet, a loop, a strap, and a glove, but the example is not limited thereto. In some embodiments, for ease of description, descriptions are provided based on an example in which the body coupling component 1440 or 1445 is in the form of a handle. However, the scope of the embodiments shall not be limited thereto.

The intended exercise posture may be defined as a path of a hand or an arm to move or a specific exercise posture. The wearable device 1400 may adjust the tension of the cable 1430 or 1435 to a low value when a change in the position of the user's hand over time corresponds to the intended exercise posture and when the change in the position of the user's hand over time does not correspond to the intended exercise posture, the wearable device 1400 may induce the user's hand to move to an exercise posture intended by the user 110 by adjusting the tension of the cable 1430 or 1435 to a high value. The tension of the low value may cause the user 110 to feel small resistance or not feel the resistance from the cable 1430 or 1435 and the tension of the high value may cause the user 110 to feel relatively great resistance from the cable 1430 or 1435. The low value and the high value of the tension may be relational and may indicate a lower value or a higher value than a specific reference value, respectively.

In an example embodiment, the wearable device 1400 may operate in a strength exercise assistance mode for enhancing the strength of the user 110. In the strength exercise assistance mode, the wearable device 1400 may hinder a body motion of the user 110 or provide resistance to a body motion of the user 110 by applying a resistance force to the body of the user 110 through the cable 1430 or 1435. In an example embodiment, the wearable device 1400 may further enhance an exercise effect by providing an exercise load to an arm motion of the user 110. The wearable device 1400 may set the resistance force of the cable 1430 or 1435 to be high when the user 110 moves to the intended exercise posture and when the user 110 moves in a different direction from the intended exercise posture, the wearable device 1400 may set the resistance force of the cable 1430 or 1435 to be low. Through this, the user 110 may perform a strength exercise with a preferable exercise posture.

In an embodiment, the wearable device 1400 may operate in a physical ability measurement mode for measuring a physical ability of the user 110. The wearable device 1400 may measure motion information of the user 110 using a sensor (e.g., an inertial sensor, a force sensor, or an angle sensor) included in the wearable device 1400 during the exercise of the user 110 and may assess the physical ability of the user 110 based on the measured motion information. For example, an exercise ability indicator (e.g., muscular strength, endurance, balance, or exercise motion) of the user 110 may be estimated through the motion information of the user 110 measured by the wearable device 1400.

The wearable device 1400 according to an example embodiment may include a first wearing part 1410, a main body module 1420, the cable 1430 or 1435 connected, directly or indirectly, to an actuator of the main body module 1420, the coupling components 1440 and 1445 connected, directly or indirectly, to the cable 1430 or 1435 and connected or fixed to a body part (e.g., hands, wrists, arms, and fingers) of the user 110, and a second wearing part 1450 or 1455. The wearable device 1400 may further include a sensor (not shown) configured to measure a hand motion of the user 110 and generate motion data corresponding to the hand motion of the user. Some (e.g., the second wearing part 1450 or 1455) of the components may be omitted and another component (e.g., a third wearing part worn on an upper arm) may be added to the wearable device 1400.

The first wearing part 1410 may be worn on the body of the user 110. For example, the first wearing part 1410 may be worn on the upper body of the user 110. The first wearing part 1410 may fit the upper body of the user 110 and support a portion of the upper body of the user 110. The first wearing part 1410 may adhere the main body module 1420 to the upper body of the user 110 to prevent, or reduce chances of, the main body module 1420 fixed to the first wearing part 1410 from being substantially shaken by the motion of the user 110. In an example embodiment, the first wearing part 1410 may include an elastic material.

The main body module 1420 may include a motor (not shown) connected, directly or indirectly, to the cable 1430 or 1435 and configured to adjust tension applied to the cable 1430 or 1435, a processor (not shown) configured to control the motor, and a battery (not shown). In an embodiment, the main body module 1420 may guide the user 110 on a preferred exercise posture or may assist a strength exercise of the user 110 by adjusting a magnitude of tension transmitted to the body coupling component 1440 or 1445 of the user 110 through the cable 1430 or 1435. The main body module 1420 may adjust the tension applied to the cable 1430 or 1435 by controlling the actuator based on a position of a hand (or an arm) of the user 110. The tension applied to the cable 1430 or 1435 may be transmitted to the body coupling component 1440 or 1445 held by the user 110. The main body module 1420 may obtain sensor data related to a position of the hand of the user 110 through at least one sensor (not shown) and may estimate a position of a hand and a posture of an arm of the user 110 based on the sensor data. The sensor data may include measured data on the motion and/or rotation of the user's hand. The at least one sensor may include, for example, an inertial measurement unit (IMU). The at least one sensor may be included in, for example, the second wearing part 1450 or 1455, the body coupling component 1440 or 1445, a third wearing part (not shown) worn on an upper arm, and/or another wearable device (e.g., a watch-type wearable device). The main body module 1420 and the at least one sensor may be connected, directly or indirectly, to each other by wire or wirelessly.

When the first wearing part 1410 is worn on an upper body of the user 110, the main body module 1420 may be positioned on a backside (e.g., the back) of the upper body of the user 110. However, the example is not limited thereto. For example, the main body module 1420 may be positioned on a front side (e.g., the chest) of the upper body.

An end of the cable 1430 or 1435 may be connected, directly or indirectly, to the body coupling component 1440 or 1445. In an embodiment, the body coupling component 1440 or 1445 and the second wearing part 1450 or 1455 may be worn to be positioned on the hand and the wrist of the user 110, respectively. The body coupling component 1440 or 1445 may have a shape that the user 110 is able to grip by hand, but the shape of the body coupling component 1440 or 1445 is not limited to the described embodiments. The body coupling component 1440 or 1445 may have a shape that may be fixed to a portion of the hand or arm of the user 110. The cable 1430 or 1435 is connected, directly or indirectly, to the motor in the main body module 1420, and tension and/or length thereof may change according to a motion of the hand (or the arm) of the user 110. The cable 1430 or 1435 may be an elastic cable, an inelastic cable, or a combination thereof.

The second wearing part 1450 or 1455 may position an end of the cable 1430 or 1435 to be closely in contact with the body of the user 110 even in a state in which the user 110 does not grip the body coupling component 1440 or 1445. The second wearing part 1450 or 1455 may include, for example, a sensor, such as an inertial sensor and a biometric sensor, a communication module (not shown) for communicating with the sensor, and a battery (not shown) for power supply. For example, the biometric sensor may sense a heart rate of the user 110.

In the illustrated embodiment, the body coupling component 1440 or 1445 and the second wearing part 1450 or 1455 have separate shapes from each other, but depending on embodiments, the body coupling component 1440 or 1445 and the second wearing part 1450 or 1455 may be manufactured to have one shape (e.g., in the form of gloves) as an integral body. In the wearable device 1400, the cable 1430 or 1435, the body coupling component 1440 or 1445, and the second wearing part 1450 or 1455 are respectively provided as two for both arms of the user 110, but only one of each may be included for only one arm. In addition, the wearable device 1400 may operate for both arms or may operate for only one arm. For example, when the user 110 performs exercise only on a right arm (or a right hand), the user 110 may grip the first body coupling component 1440 and may perform exercise on the right arm based on resistance transmitted by the first cable 1430.

The user 110 may wear the wearable device 1400 and train an exercise posture or perform various types of exercises using the wearable device 1400. For example, the user 110 may perform various exercises such as weight training, boxing, Pilates, stretching, or yoga while wearing the wearable device. In an example embodiment, the wearable device 1400 may guide the user 110 to naturally move an arm in a preferred exercise posture by providing resistance through the cable 1430 or 1435 when the user 110 moves the arm in a posture that is not the preferred exercise posture. Alternatively, the wearable device 1400 may assist the user 110 to perform a strength exercise in a preferred exercise posture by providing high resistance when the user moves in the preferred exercise posture.

In an embodiment, a processor (e.g., the processor 710 of FIG. 7) of the electronic device 210 may control the tension of the cable 1430 or 1435 of the wearable device 1400 in a manner similar to that described above. A tension parameter that controls the tension of the cable 1430 or 1435 may correspond to, for example, the torque parameter described with reference to the preceding drawings. When the tension parameter is changed, a driving characteristic of the wearable device 1400 may vary. For example, as the tension parameter is changed, it may become difficult or easy for the user 110 to pull the cable 1430 or 1435.

In an embodiment, the processor may determine a tension parameter for achieving the exercise goal of the user by using the neural network model according to a manner similar to that described with reference to FIG. 12. The neural network model may receive, as an input, feature data related to the exercise of the user (e.g., an exercise session timestamp, an exercise section timestamp, or an exercise section index) and a tension parameter for a next exercise section. The neural network model may estimate a maximum speed of the user 110 in a process of extending the cable 1430 or 1435 in a forward direction and output the estimated maximum speed as output data. The processor may calculate a difference between a target maximum speed when extending the cable set by the user and the estimated maximum speed output from the neural network model as a loss and search for a tension parameter that minimizes or reduces the loss. The processor may control the tension of the wearable device 1400 in a next exercise section based on the searched-for tension parameter. In the training process of the neural network model, sensor data may be obtained using a sensor capable of measuring a moving speed of the cable 1430 or 1435, and a model parameter of the neural network model may be updated by using a maximum speed of the cable 1430 or 1435 measured through the obtained sensor data as label data.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via at least third component(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Accordingly, each “module” in the present disclosure may include a circuit.

Software may include a computer program, a piece of code, an instruction, or one or more combinations thereof, to independently or collectively instruct or configure a processing device to operate as desired. Software and/or data may be embodied permanently or temporarily in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable storage medium. Embodiments as set forth herein may be implemented as software including one or more instructions that are stored in a storage medium that is readable by a machine. For example, a processor of the machine may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although the present disclosure exemplifies and describes with reference to various embodiments, it shall be construed that various embodiments are for the illustrative purpose rather than limiting. It shall be further understood by those skilled in the art that various changes in forms and details may be made without departing from the true spirit and full scope of this disclosure including the scope of the attached claims and their equivalents. In addition, it shall be construed that the embodiments described herein may be used with other embodiments of the present disclosure.

1. A control method of controlling a wearable device based on exercise data of a user, the control method comprising:
receiving a user input for an exercise goal;
determining a torque parameter related to achievement of the exercise goal at least by using a neural network model that receives, as an input, feature data related to an exercise performed by the user while wearing the wearable device and outputs an estimated exercise performance indicator; and
transmitting a control signal including the determined torque parameter to the wearable device so that the wearable device generates torque based on the determined torque parameter.

2. The control method of claim 1, wherein the determining of the torque parameter comprises:
estimating feature data related to an exercise for a next exercise section;
inputting the feature data estimated for the next exercise section and a torque parameter corresponding to a reference value into the neural network model; and
determining a torque parameter to be applied to the next exercise section based on the estimated exercise performance indicator obtained from the neural network model and an exercise goal indicator for achievement of the exercise goal.

3. The control method of claim 2, wherein the determining of the torque parameter comprises:
searching for the torque parameter with which a difference between the estimated exercise performance indicator and the exercise goal indicator satisfies a set condition.

4. The control method of claim 3, wherein the transmitting of the control signal comprises:
in response to having searched for a torque parameter satisfying the set condition, transmitting a control signal including the searched-for torque parameter to the wearable device such that the wearable device generates torque based on the searched-for torque parameter in a next exercise section.

5. The control method of claim 1, wherein the exercise performed by the user includes a plurality of exercise sections, and
the control method further comprises:
when a first exercise section is completed, training the neural network model based on data collected up to the first exercise section; and
determining a torque parameter to be applied to a second exercise section, which is a next exercise section following the first exercise section, at least by using the trained neural network model.

6. The control method of claim 1, wherein the determining of the torque parameter comprises:
determining at least one of a first parameter that determines a magnitude of torque output from a motor of the wearable device and a second parameter that determines a point in time at which the torque is applied.

7. The control method of claim 1, wherein the receiving of the user input comprises:
receiving the user input including a selection of at least one of an exercise type, a target walking speed, and a target stride length, which are related to a target maximum heart rate.

8. The control method of claim 1, further comprising:
outputting information on the determined torque parameter; and
in response to receiving a user input including a change input for the torque parameter, determining a torque parameter changed by the change input as the torque parameter related to the achievement of the exercise goal.

9. The control method of claim 1, further comprising:
when an entire exercise section of the exercise is completed, training the neural network model based on data collected during performance of the exercise.

10. The control method of claim 9, wherein the training of the neural network model comprises:
updating a model parameter of the neural network model based on an exercise performance indicator measured based on sensor data collected during the performance of the exercise and the estimated exercise performance indicator output from the neural network model.

11. The control method of claim 1, wherein the feature data related to the exercise includes a feature value for an exercise section performed by the user.

12. The control method of claim 11, wherein the feature data related to the exercise further includes at least one of a feature value for an elapsed exercise time and a feature value for whether a torque parameter has been changed by a user input.

13. The control method of claim 1, wherein the estimated exercise performance indicator includes at least one of a heart rate, a walking speed, and a stride length of the user.

14. A computer-readable storage medium storing instructions that, when executed by one or more processors, cause the one or more processors to individually and/or collectively perform the method of claim 1.

15. An electronic device comprising:
one or more processors each comprising processing circuitry;
an input circuit configured to receive a user input; and
communication circuitry configured to communicate with a wearable device,
wherein the one or more processors is/are individually and/or collectively configured to:
in response to receiving a user input for an exercise goal through the input circuit,
determine a torque parameter related to achievement of the exercise goal at least by using a neural network model configured to receive, as an input, feature data related to an exercise performed by a user while wearing the wearable device and output an estimated exercise performance indicator, and
cause the communication circuitry to transmit a control signal including the determined torque parameter to the wearable device, thereby controlling the wearable device to generate torque based on the determined torque parameter.

16. The electronic device of claim 15, wherein the one or more processors is/are individually and/or collectively configured to:
estimate feature data related to an exercise for a next exercise section, input the feature data estimated for the next exercise section and a torque parameter corresponding to a reference value into the neural network model, and
determine a torque parameter to be applied to the next exercise section based on the estimated exercise performance indicator obtained from the neural network model and an exercise goal indicator for achievement of the exercise goal.

17. The electronic device of claim 15, wherein the one or more processors is/are individually and/or collectively configured to:
search for the torque parameter with which a difference between the estimated exercise performance indicator and the exercise goal indicator satisfies a set condition.

18. The electronic device of claim 15, wherein the exercise performed by the user includes a plurality of exercise sections, and the one or more processors is/are individually and/or collectively configured to:
when a first exercise section is completed, train the neural network model based on data collected up to the first exercise section, and
determine a torque parameter to be applied to a second exercise section, which is a next exercise section following the first exercise section, at least by using the trained neural network model.

19. The electronic device of claim 15, wherein the one or more processors is/are individually and/or collectively configured to:
when an entire exercise section of the exercise is completed, update a model parameter of the neural network model based on an exercise performance indicator measured based on sensor data collected during the performance of the exercise and the estimated exercise performance indicator output from the neural network model.

20. The electronic device of claim 15, wherein the feature data related to the exercise includes a feature value for an exercise section performed by the user, and the estimated exercise performance indicator includes at least one of a heart rate, a walking speed, and a stride length of the user.
